(19) United States
(12) Patent Application Publication
(10) Pub. No.: US 2020/0407835 A1
(43) Pub. Date: Dec. 31, 2020

(54) NITRIDED STAINLESS STEELS WITH HIGH STRENGTH AND HIGH DUCTILITY

(71) Applicant: Apple Inc., Cupertino, CA (US)

(72) Inventors: Hoishun Li, San Jose, CA (US); Brian M. Gable, San Jose, CA (US); James A. Yurko, Saratoga, CA (US)

(21) Appl. No.: 16/910,999

(22) Filed: Jun. 24, 2020

Related U.S. Application Data
(60) Provisional application No. 62/866,865, filed on Jun. 26, 2019.
(60) Provisional application No. 62/906,323, filed on Sep. 26, 2019.

(51) Int. Cl. C23C 8/26; C22C 38/58; C22C 38/02; C22C 38/00; B22F 3/10; B22F 3/00; B22F 3/22; B33Y 10/00; B33Y 70/00

(52) U.S. Cl. CPC C23C 8/26; C22C 38/58; C22C 38/02; C22C 38/001; B22F 3/10; B22F 2301/35; B22F 3/225; B33Y 10/00; B33Y 70/00; B22F 2201/02; B22F 3/008

(57) ABSTRACT

The disclosure provides a method of hardening an Fe-based alloy. The method may include cold rolling the Fe-based alloy to form a cold rolled alloy. The method may also include heating the cold rolled alloy to an elevated temperature in a nitrogen-containing gas to form a nitrided hardened Fe-based alloy. The nitrided hardened Fe-based alloy comprises N from 0.035 to 2.0 wt %.

### PRIORITY

The disclosure claims the benefit under 35 U.S.C. § 119(e) of U.S. Provisional Patent Application No. 62/866,865, entitled “NITRIDED STAINLESS STEELS WITH HIGH STRENGTH AND HIGH DUCTILITY,” filed on Jun. 26, 2019, and of U.S. Provisional Patent Application No. 62/906,323, entitled “NITRIDED STAINLESS STEELS WITH HIGH STRENGTH AND HIGH DUCTILITY,” filed on Sep. 26, 2019, each of the foregoing applications is incorporated herein by reference in its entirety.

### FIELD

The disclosure is directed to alloy compositions and methods for manufacturing of nitrided stainless steels with high strength and high ductility as well as good corrosion resistance.

### BACKGROUND

Conventionally, thin stainless steel foils can be formed of full-hard 301 stainless steels (301 SS). The method for forming 301 stainless steel (301 SS) foils is by repeatedly cold rolling the 301 SS to produce dislocations in the stainless steel through cold working, reducing the thickness in the cold working process. Several steps of cold rolling can be needed for a single alloy to achieve the desired strength or hardness or thickness. A side effect of the cold rolling is the reduction of ductility of the material. Low ductility may result in material failures.

The 301 SS has better work hardening ability than other stainless steels. However, the work hardened 301 SS is magnetic. The 301 SS also has poor corrosion resistance, which limits its application to non-cosmetic internal components.

There still remains a need to develop non-magnetic stainless steel alloys with improved work hardening ability and better corrosion resistance.

### BRIEF SUMMARY

In one aspect, the disclosures provides an Fe-based alloy. The alloy may include 13-21 wt % Cr; 5-16 wt % Ni; less than or equal to 4.5 wt % Mn; 0.035-2.0 wt % N; less than or equal to 1.0 wt % Si; and less than or equal to 0.15 wt % C, wherein the balance is Fe and trace elements.

In one aspect, the disclosure provides an Fe-based alloy. In some variations, the alloy may include 13-21 wt % Cr, 5-16 wt % Ni, less than or equal to 3.0 wt % Mn, 0.035-2.0 wt % N, less than or equal to 1.0 wt % Si, and less than or equal to 0.15 wt % C. The balance is Fe and trace elements.

In another aspect, the alloy may include 17-21 wt % Cr, 7-13 wt % Ni, less than or equal to 3.0 wt % Mn, 0.035-1.50 wt % N, less than or equal to 1.0 wt % Si, and less than or equal to 0.10 wt % C, with the balance being Fe and trace elements.

In another aspect, the alloy may include 15-19 wt % Cr, 10-16 wt % Ni, 1-4 wt % Mo, less than or equal to 3.0 wt % Mn, 0.03-1.5 wt % N, less than or equal to 1.0 wt % Si, and less than or equal to 0.10 wt % C, with the balance being Fe and trace elements.

In another aspect, the 15-19 wt % C, 5-9 wt % Ni, less than or equal to 3.0 wt % Mn, 0.02-2.0 wt % N, less than or equal to 1.0 wt % Si, and less than or equal to 0.10 wt % C, with the balance being Fe and trace elements

In another aspect, the disclosure provides a method of hardening an Fe-based alloy. The method may include cold rolling the Fe-based alloy to form a cold rolled alloy. The method may also include heating the cold rolled alloy to an elevated temperature in a nitrogen-containing gas to form a nitrided hardened Fe-based alloy. The nitrided hardened Fe-based alloy comprises N from 0.035 to 2.0 wt %.

In another aspect, a method of forming a nitrided hardened sintered Fe-based article is provided. The method may include placing an article containing a pre-compacted Fe-based powder inside a sintering furnace. The method may also include filling the sintering furnace with a N₂ gas. The method may further include simultaneously sintering and nitriding the article comprising the pre-compacted Fe-based powder to an elevated temperature to form a nitrided and sintered Fe-based article. The nitrided and sintered Fe-based article comprises N from 0.035 to 2.0 wt %.

In some aspects, the method may also include cooling the nitrided and sintered Fe-based powder to form the nitrided hardened Fe-based article.

In some aspects, the nitrogen-containing gas has a gas pressure up to 10 bars.

In some aspects, the elevated temperature is lower than the melting temperature of the Fe-based powder.

In a further aspect, a method of 3D printing or metal injection molding an Fe-based powder is provided. The method may include molding a feedstock comprising a pre-compacted Fe-based powder mixed with a polymer binder to form a shaped article. The method may also include simultaneously a) sintering and b) nitriding the shaped article and c) removing the polymer binder in a nitrogen-containing gas at an elevated temperature to form a nitrided hardened Fe-based article. The nitrided hardened Fe-based powder comprises N from 0.035 to 2.0 wt %.

In one aspect, the disclosure provides an Fe-based alloy. The alloy may include 16 to 21 wt % Cr; 8 to 13 wt % Ni; less than or equal to 4.5 wt % Mn; 0.035 to 2.0 wt % N; 0.03 to 1.0 wt % Si; and 0.02 to 0.15 wt % C, wherein the balance is Fe and trace elements.

Additional embodiments and features are set forth in part in the description that follows, and will become apparent to those skilled in the art upon examination of the specification or may be learned by the practice of the disclosed subject matter. A further understanding of the nature and advantages of the disclosure may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as various embodiments of the disclosure and should not be construed as a complete recitation of the scope of the disclosure, wherein:

FIG. 1 is a flow chart illustrating a manufacturing process including nitriding Fe-based alloys in accordance with embodiments of the disclosure;

FIG. 2 shows work hardening rate versus area reduction % for 316L and 316L-0.15N alloys in accordance with embodiments of the disclosure;

FIG. 3A illustrates nitrogen solubility versus N₂ pressure at various elevated temperatures for a 304L alloy (Fe-20Cr-8Ni-1.9Mn-0.4Si-0.02C-0.1N) in accordance with embodiments of the disclosure;

FIG. 3B illustrates nitrogen solubility versus N₂ pressure at various elevated temperatures for a 304L alloy (Fe-18Cr-10Ni-1.9Mn-0.75Si-0.02C-0.1N) in accordance with embodiments of the disclosure;

FIG. 3C illustrates penetration depth versus nitriding time for a 304L alloy in accordance with embodiments of the disclosure;

FIG. 4 illustrates true stress versus true strain curve for 304L and 304LN alloys in accordance with embodiments of the disclosure;

FIG. 5 illustrates true stress versus true strain curve for 316L and 304LN alloys in accordance with embodiments of the disclosure;

FIG. 6 illustrates true stress versus true strain curve for 301 and 304LN alloys in accordance with embodiments of the disclosure;

FIG. 7 illustrates true stress versus true strain curve for comparison of 304LN with other Fe-based alloys in accordance with embodiments of the disclosure;

FIG. 8 illustrates hardness versus cold work reduction for 304LN and other Fe-based alloys in accordance with embodiments of the disclosure;

FIG. 9A illustrates nitrogen solubility versus N₂ pressure at various elevated temperatures for a 316L alloy (Fe-18Cr-10Ni-3Mo-1.9Mn-0.4Si-0.02C-0.1N) in accordance with embodiments of the disclosure;

FIG. 9B illustrates nitrogen solubility versus N₂ pressure at various elevated temperatures for a 316L alloy (Fe-16Cr-14Ni-2Mo-1.0Mn-0.75Si-0.02C-0.1N) in accordance with embodiments of the disclosure;

FIG. 9C illustrates penetration depth versus nitriding time for a 316L alloy in accordance with embodiments of the disclosure;

FIG. 10A illustrates nitrogen solubility versus N₂ pressure at various elevated temperatures for a 301L alloy (Fe-18Cr-6Ni-1.9Mn-0.4Si-0.12C-0.1N) in accordance with embodiments of the disclosure;

FIG. 10B illustrates nitrogen solubility versus N₂ pressure at various elevated temperatures for a 301L alloy (Fe-16Cr-8Ni-1.0Mn-0.8Si-0.12C-0.1N) in accordance with embodiments of the disclosure;

FIG. 11A depicts a sketch illustrating a system for dual sintering and nitriding of powder in accordance with embodiments of the disclosure;

FIG. 11B illustrates changes of packing particles after sintering in accordance with embodiments of the disclosure;

FIG. 12 is a flow chart illustrating the steps of dual sintering and nitriding of powder in accordance with embodiments of the disclosure;

FIG. 13 depicts a sketch illustrating a system for dual metal injection molding and nitriding of powder in accordance with embodiments of the disclosure; and

FIG. 14 is a flow chart illustrating the steps of dual metal injection molding and nitriding of powder in accordance with embodiments of the disclosure.

### DETAILED DESCRIPTION

The disclosure may be understood by reference to the following detailed description, taken in conjunction with the drawings as described below. It is noted that, for purposes of illustrative clarity, certain elements in various drawings may not be drawn to scale.

The disclosure is directed to stainless steels, and fabrication thereof of stainless steels with high strength, high fatigue resistant, and/or high ductility by using cold rolling and nitriding. The disclosure further provides an alternative way to process stainless steel, including 304 SS, 301 SS, 316 SS, or similar alloys, to achieve similar or better properties than the full-hard 301 SS alloy. Also, the disclosed nitrided Fe-based alloys, such as 304LN SS, 316LN SS, and 301LN SS, are non-magnetic, and have high strength, high hardness with good ductility, improved fatigue resistance, and corrosion resistance. The disclosed 304, 301, 316 stainless steels, or similar steel alloys can be in any form including a foil form, a sheet form, a bar form, among others.

In some variations, nitriding can increase stainless steel's work hardening ability due to increased nitrogen content. The improved work hardening ability means that less cold work may be needed to achieve the same amount of strength increase, and thus the material can have higher ductility. The work hardening ability is defined as the following Equation (1):

work hardening ability=Δσ/% CW Equation (1)

where ac denotes a strength increase, and % CW denotes percent of cold work reduction.

The percent of cold work (% CW) is a measure of plastic deformation defined by the following Equation (2):

% CW=(Aₒ−A_{d})/Aₒ×100 Equation (2)

where Aₒ is the original cross-section area, and A_{d} is the area after deformation.

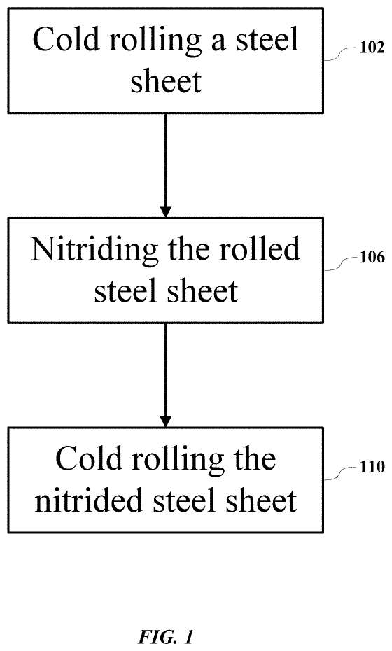

FIG. 1 is a flow chart illustrating a manufacturing process including nitriding Fe-based alloys in accordance with embodiments of the disclosure. The process 100 includes cold working an Fe-based alloy to form a cold rolled alloy at operation 102. Cold-rolled steel is produced in cold reduction mills where the material is cooled at room temperature. Cold-rolled steel contains a low carbon content.

Cold-rolled steel sheets and strips may be provided in full-hard, or half-hard conditions, among other conditions. The full-hard condition can have 70% cold work reduction, while the half-hard condition can have 30-50% cold work reduction.

The process 100 also includes nitriding the cold rolled alloy to forma nitride alloy at operation 106. Nitriding is a heat treating process that diffuses nitrogen into a metal to increase the work hardening ability. The nitriding process is most commonly used on low-carbon, low-alloy steels.

In gas nitriding, the donor is a nitrogen gas (N₂) or a nitrogen rich gas (e.g. ammonia (NH₃)). When the nitrogen gas comes into contact with a heated workpiece which still remains in a solid state, the nitrogen gas diffuses onto the workpiece, increasing the work hardening ability of the workpiece. The amount of nitrogen in the workpiece and the process parameters can be selected for particular properties required. The gas nitriding can have precise control of gas flow rate of nitrogen. The equipment cost is significantly lower than that of plasma nitriding.

In some embodiments, nitriding may be performed at an elevated temperature for a period of time with a nitrogen gas. For example, nitriding may be performed in a furnace filled with nitrogen gas. The furnace may be heated to at least 1000° C., alternatively to at least 1100° C., alternatively to at least 1200° C., or alternatively to 1300° C. In some embodiments, the furnace can be heated to the elevated temperature for a period of time, such as up to 30 hours, with a gas pressure up to 6 bars. The time can depend on the thickness. By way of example and not limitation, a thickness of 0.5 mm, and it can take about 0.5 hour for nitriding. For a thickness of up to 4 mm, it can take up to 30 hours for nitriding.

It will be appreciated by those skilled in the art that the gas pressure and furnace temperature, as well as nitriding time, may vary to affect the nitrogen content.

The cold rolled alloy can be nitrided to form a nitrided alloy. The cold rolled alloy prior to nitriding may have a body centered cubic (BCC) crystal structure, and may be magnetic. The nitrided alloy may have a face centered cubic (FCC) crystalline structure, and may be non-magnetic.

The manufacturing process 100 may also include cold working the nitrided alloy at operation 110.

In some embodiments, the process may include additional nitriding and further cold working to strengthen the alloy.

Annealing

After cold working and nitriding, the process may continue with annealing and cold rolling, which can produce steel with a wide range of surface finishes. The annealing process makes the cold-rolled steel softer. Cold-rolled steel products are commonly produced in sheets, strips, bars and rods. Annealing may be done at the same temperature as the temperature for nitriding. The annealing duration may vary with the size of the material, from 10 min to one hour. After annealing, the material needs to be cooled rapidly, either by forced air, water, or oil.

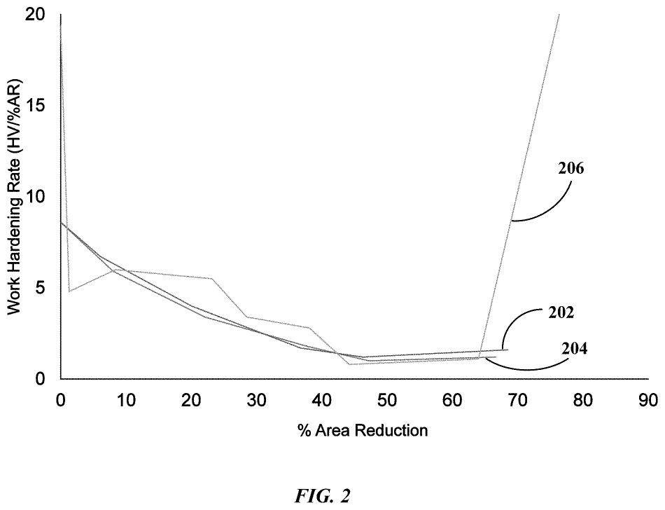

FIG. 2 shows work hardening rate versus area reduction % for 316L alloy and 316L-0.15N nitrided alloy in accordance with embodiments of the disclosure. The 316L-0.15N included 0.15 wt % nitrogen (N). Curves 202 and 204 represent 316L-0.15N and 316L, respectively. As shown in FIG. 2, the work hardening rate for the 316L-0.15N alloy was about the same as that for 316L alloy. The 316L-0.15N did not increase the work hardening rate with 0.15 wt % N. The work hardening rate decreases with the % CW or % area reduction. For example, the work hardening rate does not improve any more after about 50% area reduction.

The 304L-0.6N nitrided alloy shows higher work hardening rate than the 316L-0.15N alloy. As shown by curve 206 in FIG. 2, the hardening rate starts to decrease with the area reduction to about 1, but then starts to increase around about 65% area reduction at a very steep slope. The hardening rate becomes about 20 around 75% area reduction. The 304L-0.6N nitrided alloy includes 0.6 wt % nitrogen, which was higher than 0.15 wt % for the 316L-0.15N nitride alloy.

Alloys

The disclosure provides iron-based alloys including chromium (Cr) ranging from 13.0 wt % to 21.0 wt %, nickel (Ni) ranging from 5.0 wt % to 16.0 wt %, manganese (Mn) less than or equal to 4.5 wt %, nitrogen (N) from 0.02 wt % to 2.0 wt %, less than or equal to 1.0 wt % silicon (Si), and carbon (C) less than or equal to 0.15 wt %. In some instances, the alloy has less than or equal to 4.0 wt % molybdenum (Mo). In some variations, the iron-based alloys can be 304LN, 301LN, and 316LN. In particular, Ni content is higher than commercial stainless steel alloys, such as stainless steel 304L, 301L, and 316L. In some variations, the iron-based alloys can be 3xx stainless steels with Mn up to 6.0 wt %. Various other elements can be included in the alloys, as described herein.

Nitrided 304 Stainless Steel

In some variations, the disclosure provides iron-based alloys including chromium (Cr) ranging from 17.0 wt % to 21.0 wt %, nickel (Ni) ranging from 7.0 wt % to 13.0 wt %, manganese (Mn) less than or equal to 2.0 wt %, nitrogen (N) from 0.035 wt % to 1.5 wt %, silicon (Si) less than or equal to 1.0 wt %, and carbon (C) less than or equal to 0.08 wt %. The disclosure provides iron-based alloys including chromium (Cr) ranging from 18.0 wt % to 20.0 wt %, nickel (Ni) ranging from 8.0 wt % to 12.0 wt %, manganese (Mn) less than or equal to 2.0 wt %, nitrogen (N) from 0.035 wt % to 1.5 wt %, silicon (Si) less than or equal to 1.0 wt %, and carbon (C) less than or equal to 0.08 wt %.

The iron-based alloy can include chromium (Cr). In some variations, increasing Cr resists corrosion in the alloy. In some embodiments, the iron-based alloys include Cr from 17.0 to 21.0 wt %. In some embodiments, the iron-based alloys include Cr from 18.0 to 20.0 wt %. In some embodiments, the alloys include Cr equal to or less than 21.0 wt %. In some embodiments, the alloys include Cr equal to or less than 20.0 wt %. In some embodiments, the alloys include Cr equal to or less than 19.5 wt %. In some embodiments, the alloys include Cr equal to or less than 19.0 wt %. In some embodiments, the alloys include Cr equal to or less than 18.5 wt %. In some embodiments, the alloys include Cr equal to or less than 18.0 wt %. In some embodiments, the alloys include Cr equal to or less than 17.5 wt %. In some embodiments, the alloys include Cr at least 17.0 wt %. In some embodiments, the alloys include Cr at least 17.5 wt %. In some embodiments, the alloys include Cr at least 18.0 wt %. In some embodiments, the alloys include Cr at least 18.5 wt %. In some embodiments, the alloys include Cr at least 19.0 wt %. In some embodiments, the alloys include Cr at least 19.5 wt %. In some embodiments, the alloys include Cr at least 20.0 wt %. In some embodiments, the alloys include Cr at least 20.5 wt %.

In some embodiments, the iron-based alloys include nickel (Ni) from 7.0 to 13.0 wt %. In some embodiments, the iron-based alloys include nickel (Ni) from 8.0 to 12.0 wt %. In some embodiments, the alloys include Ni equal to or less than 13.0 wt %. In some embodiments, the alloys include Ni equal to or less than 12.5 wt %. In some embodiments, the alloys include Ni equal to or less than 12.0 wt %. In some embodiments, the alloys include Ni equal to or less than 11.5 wt %. In some embodiments, the alloys include Ni equal to or less than 11.0 wt %. In some embodiments, the alloys include Ni equal to or less than 10.5 wt %. In some embodiments, the alloys include Ni equal to or less than 10.0 wt %. In some embodiments, the alloys include Ni equal to or less than 9.5 wt %. In some embodiments, the alloys include Ni equal to or less than 9.0 wt %. In some embodiments, the alloys include Ni equal to or less than 8.5 wt.

In some embodiments, the alloys include Ni equal to or greater than 7.0 wt %. In some embodiments, the alloys include Ni equal to or greater than 7.5 wt %. In some embodiments, the alloys include Ni equal to or greater than 8.0 wt %. In some embodiments, the alloys include Ni equal to or greater than 8.5 wt %. In some embodiments, the alloys include Ni equal to or greater than 9.0 wt %. In some embodiments, the alloys include Ni equal to or greater than 9.5 wt %. In some embodiments, the alloys include Ni equal to or greater than 10.0 wt %. In some embodiments, the alloys include Ni equal to or greater than 10.5 wt %. In some embodiments, the alloys include Ni equal to or greater than 11.0 wt %. In some embodiments, the alloys include Ni equal to or greater than 11.5 wt %. In some embodiments, the alloys include Ni equal to or greater than 12.0 wt %. In some embodiments, the alloys include Ni equal to or greater than 12.5 wt %.

In some embodiments, the iron-based alloys include manganese (Mn) less than or equal to 3.0 wt %. In some embodiments, the iron-based alloys include manganese (Mn) less than or equal to 2.5 wt %. In some embodiments, the alloys include less than or equal to 2.0 wt % Mn. In some embodiments, the alloys include less than or equal to 1.5 wt % Mn. In some embodiments, the alloys include less than or equal to 1.0 wt % Mn. In some embodiments, the alloys include less than or equal to 0.5 wt % Mn. In some embodiments, the alloys include less than or equal to 0.4 wt % Mn. In some embodiments, the alloys include less than or equal to 0.3 wt % Mn. In some embodiments, the alloys include less than or equal to 0.2 wt % Mn. In some embodiments, the alloys include less than or equal to 0.1 wt % Mn. In some variations, the alloy includes Mn in an amount of at least 0.2 wt %. In some variations, the alloy includes Mn in an amount of at least 0.5 wt %. In some variations, the alloy includes Mn in an amount of at least 1.0 wt %. In some variations, the alloy includes Mn in an amount of at least 2.0 wt %.

In some embodiments, the alloys include Si in an amount less than or equal to 1.0 wt %. In some embodiments, the alloys include Si in an amount less than or equal to 0.75 wt %. In some embodiments, the alloys include Si in an amount less than or equal to 0.70 wt %. In some embodiments, the alloys include Si in an amount less than or equal to 0.65 wt %. In some embodiments, the alloys include Si in an amount less than or equal to 0.60 wt %. In some embodiments, the alloys include Si in an amount less than or equal to 0.55 wt %. In some embodiments, the alloys include Si in an amount less than or equal to 0.50 wt %. In some embodiments, the alloys include Si in an amount less than or equal to 0.40 wt %. In some embodiments, the alloys include Si in an amount less than or equal to 0.30 wt %. In some embodiments, the alloys include Si in an amount less than or equal to 0.20 wt %. In some embodiments, the alloys include Si in an amount less than or equal to 0.10 wt %. In some variations, the alloys include Si

In some variations, the iron-based alloys can include nitrogen (N). In various aspects, nitrogen provides for austenite formation (i.e. forming FCC) during nitriding, and corresponding hardening and mechanical strength. In various additional aspects, nitrogen can increase resistance to localized corrosion, especially in combination with molybdenum.

The iron-based alloys can have 0.035 to 1.5 wt % nitrogen (N). In some embodiments, the alloy includes N equal to or greater than 0.035 wt %. In some embodiments, the alloy includes N equal to or greater than 0.040 wt %. In some embodiments, the alloy includes N equal to or greater than 0.045 wt %. In some embodiments, the alloy includes N equal to or greater than 0.050 wt %. In some embodiments, the alloy includes N equal to or greater than 0.055 wt %. In some embodiments, the alloy includes N equal to or greater than 0.060 wt %. In some embodiments, the alloy includes N equal to or greater than 0.065 wt %. In some embodiments, the alloy includes N equal to or greater than 0.070 wt %. In some embodiments, the alloy includes N equal to or greater than 0.075 wt %. In some embodiments, the alloy includes N equal to or greater than 0.080 wt %. In some embodiments, the alloy includes N equal to or greater than 0.085 wt %. In some embodiments, the alloy includes N equal to or greater than 0.090 wt %. In some embodiments, the alloy includes N equal to or greater than 0.095 wt %. In some embodiments, the alloy includes N equal to or greater than 0.1 wt %. In some embodiments, the alloy includes N equal to or greater than 0.2 wt %. In some embodiments, the alloy includes N equal to or greater than 0.3 wt %. In some embodiments, the alloy includes N equal to or greater than 0.4 wt %. In some embodiments, the alloy includes N equal to or greater than 0.5 wt %. In some embodiments, the alloy includes N equal to or greater than 0.6 wt %. In some embodiments, the alloy includes N equal to or greater than 0.7 wt %. In some embodiments, the alloy includes N equal to or greater than 0.8 wt %. In some embodiments, the alloy includes N equal to or greater than 0.9 wt %. In some embodiments, the alloy includes N equal to or greater than 1.0 wt %. In some embodiments, the alloy includes N equal to or greater than 1.05 wt %. In some embodiments, the alloy includes N equal to or greater than 1.10 wt %. In some embodiments, the alloy includes N equal to or greater than 1.15 wt %. In some embodiments, the alloy includes N equal to or greater than 1.20 wt %. In some embodiments, the alloy includes N equal to or greater than 1.25 wt %. In some embodiments, the alloy includes N equal to or greater than 1.30 wt %. In some embodiments, the alloy includes N equal to or greater than 1.35 wt %. In some embodiments, the alloy includes N equal to or greater than 1.40 wt %. In some embodiments, the alloy includes N equal to or greater than 1.45 wt %.

In some embodiments, the alloy includes N equal to or less than 1.50 wt %. In some embodiments, the alloy includes N equal to or less than 1.45 wt %. In some embodiments, the alloy includes N equal to or less than 1.40 wt %. In some embodiments, the alloy includes N equal to or less than 1.35 wt %. In some embodiments, the alloy includes N equal to or less than 1.30 wt %. In some embodiments, the alloy includes N equal to or less than 1.25 wt %. In some embodiments, the alloy includes N equal to or less than 1.20 wt %. In some embodiments, the alloy includes N equal to or less than 1.15 wt %. In some embodiments, the alloy includes N equal to or less than 1.10 wt %. In some embodiments, the alloy includes N equal to or less than 1.05 wt %. In some embodiments, the alloy includes N equal to or less than 1.00 wt %. In some embodiments, the alloy includes N equal to or less than 0.95 wt %. In some embodiments, the alloy includes N equal to or less than 0.90 wt %. In some embodiments, the alloy includes N equal to or less than 0.85 wt %. In some embodiments, the alloy includes N equal to or less than 0.80 wt %. In some embodiments, the alloy includes N equal to or less than 0.75 wt %. In some embodiments, the alloy includes N equal to or less than 0.70 wt %. In some embodiments, the alloy includes N equal to or less than 0.65 wt %. In some embodiments, the alloy includes N equal to or less than 0.60 wt %. In some embodiments, the alloy includes N equal to or less than 0.55 wt %. In some embodiments, the alloy includes N equal to or less than 0.50 wt %. In some embodiments, the alloy includes N equal to or less than 0.45 wt %. In some embodiments, the alloy includes N equal to or less than 0.40 wt %. In some embodiments, the alloy includes N equal to or less than 0.35 wt %. In some embodiments, the alloy includes N equal to or less than 0.30 wt %. In some embodiments, the alloy includes N equal to or less than 0.25 wt %. In some embodiments, the alloy includes N equal to or less than 0.20 wt %. In some embodiments, the alloy includes N equal to or less than 0.15 wt %. In some embodiments, the alloy includes N equal to or less than 0.10 wt %. In some embodiments, the alloy includes N equal to or less than 0.05 wt %. In some embodiments, the alloy includes N equal to or less than 0.045 wt %. In some embodiments, the alloy includes N equal to or less than 0.04 wt %. In some embodiments, the alloy includes N equal to or less than 0.035 wt %. In some embodiments, the alloy includes N equal to or less than 0.03 wt %. In some embodiments, the alloy includes N equal to or less than 0.025 wt %.

It will be appreciated by one of the skilled in the art that the estimated maximum solubility may vary with the ranges of the temperature and N₂ gas pressure and the alloy composition.

The iron-based alloy can include copper (Cu). In some embodiments, the alloys include Cu less than or equal to 3.0 wt %. In some embodiments, the alloys include Cu less than or equal to 2.5 wt %. In some embodiments, the alloys include Cu less than or equal to 2.0 wt %. In some embodiments, the alloys include Cu less than or equal to 1.5 wt %. In some embodiments, the alloys include Cu less than or equal to 1.0 wt %. In some embodiments, the alloys include Cu less than or equal to 0.5 wt %. In some embodiments, the alloys include Cu less than or equal to 0.4 wt %. In some embodiments, the alloys include Cu less than or equal to 0.3 wt %. In some embodiments, the alloys include Cu less than or equal to 0.2 wt %. In some embodiments, the alloys include Cu less than or equal to 0.1 wt %.

In some variations, the annealed 304LN nitrided alloy has an ultimate strength of at least 600 MPa. In some variations, the annealed 304LN nitrided alloy has an ultimate strength of at least 650 MPa. In some variations, the annealed 304LN nitrided alloy has an ultimate strength of at least 700 MPa. In some variations, the annealed 304LN nitrided alloy has an ultimate strength of at least 750 MPa. In some variations, the annealed 304LN nitrided alloy has an ultimate strength of at least 800 MPa. In some variations, the annealed 304LN nitrided alloy has an ultimate strength of at least 850 MPa.

In some variations, the 304LN 75% cold roll nitrided alloy has an ultimate strength of at least 1350 MPa. In some variations, the 304LN 75% cold roll nitrided alloy has an ultimate strength of at least 1400 MPa. In some variations, the 304LN 75% cold roll nitrided alloy has an ultimate strength of at least 1450 MPa. In some variations, the 304LN 75% cold roll nitrided alloy has an ultimate strength of at least 1500 MPa. In some variations, the 304LN 75% cold roll nitrided alloy has an ultimate strength of at least 1550 MPa.

In some variations, the 304LN 75% cold roll nitrided alloy has a yield strength of at least 1100 MPa. In some variations, the 304LN 75% cold roll nitrided alloy has a yield strength of at least 1150 MPa. In some variations, the 304LN 75% cold roll nitrided alloy has a yield strength of at least 1200 MPa. In some variations, the 304LN 75% cold roll nitrided alloy has a yield strength of at least 1250 MPa. In some variations, the 304LN 75% cold roll nitrided alloy has a yield strength of at least 1300 MPa. In some variations, the 304LN 75% cold roll nitrided alloy has a yield strength of at least 1350 MPa.

In some variations, the 304LN 75% cold roll nitrided alloy has an elongation of at least 4%. In some variations, the 304LN nitrided alloy 75% cold roll has an elongation of at least 4.5%. In some variations, the 304LN 75% cold roll nitrided alloy has an elongation of at least 5%. In some variations, the 304LN 75% cold roll nitrided alloy has an elongation of at least 5.5%. In some variations, the 304LN 75% cold roll nitrided alloy has an elongation of at least 6%.

In some variations, the 304LN 25% cold roll nitrided alloy has a hardness of at least 400 Hv. In some variations, the 304LN 28% cold roll nitrided alloy has a hardness of at least 410 Hv. In some variations, the 304LN 75% cold roll nitrided alloy has a hardness of at least 420 Hv. In some variations, the 304LN 75% cold roll nitrided alloy has a hardness of at least 430 Hv. In some variations, the 304LN 38% cold roll nitrided alloy has a hardness of at least 440 Hv. In some variations, the 304LN 75% cold roll nitrided alloy has a hardness of at least 450 Hv. In some variations, the 304LN 44% cold roll nitrided alloy has a hardness of at least 460 Hv. In some variations, the 304LN 57% cold roll nitrided alloy has a hardness of at least 470 Hv. In some variations, the 304LN 64% cold roll nitrided alloy has a hardness of at least 480 Hv. In some variations, the 304LN 73% cold roll nitrided alloy has a hardness of at least 490 Hv. In some variations, the 304LN 76% cold roll nitrided alloy has a hardness of at least 500 Hv. In some variations, the 304LN 77% cold roll nitrided alloy has a hardness of is at least 510 Hv.

In some variations, the pitting potential of the 304LN nitrided alloy is at least 1250 mV_{SCE}.

It will be appreciated by those skilled in the art that corrosion resistance may vary with composition, nitrogen content, and polishing condition.

In some variations, the nitrided 304LN alloys have the magnetic permeability equal to or less than 5μ. In some variations, the nitrided Fe-based alloys have the magnetic permeability equal to or less than 4.5μ. In some variations, the nitrided Fe-based alloys have the magnetic permeability equal to or less than 4μ. In some variations, the nitrided Fe-based alloys have the magnetic permeability equal to or less than 3.5μ. In some variations, the nitrided Fe-based alloys have the magnetic permeability equal to or less than 3μ. In some variations, the nitrided Fe-based alloys have the magnetic permeability equal to or less than 2.5μ. In some variations, the nitrided Fe-based alloys have the magnetic permeability equal to or less than 2μ. In some variations, the nitrided Fe-based alloys have the magnetic permeability equal to or less than 1.5μ. In some variations, the nitrided Fe-based alloys have the magnetic permeability equal to or less than 1.0μ.

Nitrided 316 Stainless Steel

The disclosure provides iron-based alloys including chromium (Cr) ranging from 15.0 wt % to 19.0 wt %, nickel (Ni) ranging from 10.0 wt % to 16.0 wt %, manganese (Mn) less than or equal to 3.0 wt %, molybdenum (Mo) ranging from 1-4 wt %, nitrogen (N) from 0.03 wt % to 2.0 wt %, less than or equal to 1.0 wt % silicon (Si), and carbon (C) less than or equal to 0.08 wt %.

In some embodiments, the iron-based alloys include Cr from 15-19 wt %. In some embodiments, the alloys include Cr less than 19.0 wt %. In some embodiments, the alloys include Cr less than 18.5 wt %. In some embodiments, the alloys include Cr less than 18.0 wt %. In some embodiments, the alloys include Cr less than 17.5 wt %. In some embodiments, the alloys include Cr less than 17.0 wt %. In some embodiments, the alloys include Cr less than 16.5 wt %. In some embodiments, the alloys include Cr less than 16.0 wt %. In some embodiments, the alloys include Cr less than 15.5 wt %. In some embodiments, the alloys include Cr greater than or equal to 15.0 wt %. In some embodiments, the alloys include Cr greater than or equal to 15.5 wt %. In some embodiments, the alloys include Cr greater than or equal to 16.0 wt %. In some embodiments, the alloys include Cr greater than 16.5 wt %. In some embodiments, the alloys include Cr greater than or equal to 17.0 wt %. In some embodiments, the alloys include Cr greater than or equal to 17.5 wt %. In some embodiments, the alloys include Cr greater than or equal to 18.0 wt %. In some embodiments, the alloys include Cr greater than or equal to 18.5 wt %.

In some embodiments, the iron-based alloys include nickel (Ni) from 10.0 to 16.0 wt %. In some embodiments, the alloys include Ni equal to or less than 16.0 wt %. In some embodiments, the alloys include Ni equal to or less than 15.5 wt %. In some embodiments, the alloys include Ni equal to or less than 15.0 wt %. In some embodiments, the alloys include Ni equal to or less than 14.5 wt %. In some embodiments, the alloys include Ni equal to or less than 14.0 wt %. In some embodiments, the alloys include Ni equal to or less than 13.5 wt %. In some embodiments, the alloys include Ni equal to or less than 13.0 wt %. In some embodiments, the alloys include Ni equal to or less than 12.5 wt %. In some embodiments, the alloys include Ni equal to or less than 12.0 wt %. In some embodiments, the alloys include Ni equal to or less than 11.5 wt. In some embodiments, the alloys include Ni equal to or less than 11.0 wt %. In some embodiments, the alloys include Ni equal to or less than 10.5 wt.

In some embodiments, the alloys include Ni equal to or greater than 10.0 wt %. In some embodiments, the alloys include Ni equal to or greater than 10.5 wt %. In some embodiments, the alloys include Ni equal to or greater than 11.0 wt %. In some embodiments, the alloys include Ni equal to or greater than 11.5 wt %. In some embodiments, the alloys include Ni equal to or greater than 12.0 wt %. In some embodiments, the alloys include Ni equal to or greater than 12.5 wt %. In some embodiments, the alloys include Ni equal to or greater than 13.0 wt %. In some embodiments, the alloys include Ni equal to or greater than 13.5 wt %. In some embodiments, the alloys include Ni equal to or greater than 14.0 wt %. In some embodiments, the alloys include Ni equal to or greater than 14.5 wt %. In some embodiments, the alloys include Ni equal to or greater than 15.0 wt %. In some embodiments, the alloys include Ni equal to or greater than 15.5 wt %.

In some embodiments, the iron-based alloys include manganese (Mn) less than or equal to 3.0 wt %. In some embodiments, the iron-based alloys include manganese (Mn) less than or equal to 2.4 wt %. In some embodiments, the iron-based alloys include manganese (Mn) less than or equal to 2.0 wt %. In some embodiments, the alloys include less than or equal to 1.5 wt % Mn. In some embodiments, the alloys include less than or equal to 1.0 wt % Mn. In some embodiments, the alloys include less than or equal to 0.5 wt % Mn. In some embodiments, the alloys include less than or equal to 0.4 wt % Mn. In some embodiments, the alloys include less than or equal to 0.3 wt % Mn. In some embodiments, the alloys include less than or equal to 0.2 wt % Mn. In some embodiments, the alloys include less than or equal to 0.1 wt % Mn.

In some embodiments, the iron-based alloys include silicon (Si) less than or equal to 1.0 wt %. In some embodiments, the alloys include Si in an amount less than or equal to 0.95 wt %. In some embodiments, the alloys include Si in an amount less than or equal to 0.90 wt %. In some embodiments, the alloys include Si in an amount less than or equal to 0.85 wt %. In some embodiments, the alloys include Si in an amount less than or equal to 0.80 wt %. In some embodiments, the alloys include Si in an amount less than or equal to 0.75 wt %. In some embodiments, the alloys include Si in an amount less than or equal to 0.70 wt %. In some embodiments, the alloys include Si in an amount less than or equal to 0.65 wt %. In some embodiments, the alloys include Si in an amount less than or equal to 0.60 wt %. In some embodiments, the alloys include Si in an amount less than or equal to 0.55 wt %. In some embodiments, the alloys include Si in an amount less than or equal to 0.50 wt %. In some embodiments, the alloys include Si in an amount less than or equal to 0.40 wt %. In some embodiments, the alloys include Si in an amount less than or equal to 0.30 wt %. In some embodiments, the alloys include Si in an amount less than or equal to 0.20 wt %. In some embodiments, the alloys include Si in an amount less than or equal to 0.10 wt %.

The iron-based alloy can include molybdenum (Mo). In some aspects, the amount of Mo is low because it increases the necessary nitrogen gas pressure during nitriding for an equivalent alloy nitrogen content.

In some embodiments, the alloys include Mo from 1 wt % to 4 wt %. In some embodiments, the alloys include Mo from 2 wt % to 3 wt %. In some embodiments, the alloys include Mo less than or equal to 4.0 wt %. In some embodiments, the alloys include Mo less than or equal to 3.9 wt %. In some embodiments, the alloys include Mo less than or equal to 3.8 wt %. In some embodiments, the alloys include Mo less than or equal to 3.7 wt %. In some embodiments, the alloys include Mo less than or equal to 3.6 wt %. In some embodiments, the alloys include Mo less than or equal to 3.5 wt %. In some embodiments, the alloys include Mo less than or equal to 3.4 wt %. In some embodiments, the alloys include Mo less than or equal to 3.3 wt %. In some embodiments, the alloys include Mo less than or equal to 3.2 wt %. In some embodiments, the alloys include Mo less than or equal to 3.1 wt %. In some embodiments, the alloys include Mo less than or equal to 3.0 wt %. In some embodiments, the alloys include Mo less than or equal to 2.9 wt %. In some embodiments, the alloys include Mo less than or equal to 2.8 wt %. In some embodiments, the alloys include Mo less than or equal to 2.7 wt %. In some embodiments, the alloys include Mo less than or equal to 2.6 wt %. In some embodiments, the alloys include Mo less than or equal to 2.5 wt %. In some embodiments, the alloys include Mo less than or equal to 2.4 wt %. In some embodiments, the alloys include Mo less than or equal to 2.3 wt %. In some embodiments, the alloys include Mo less than or equal to 2.2 wt %. In some embodiments, the alloys include Mo less than or equal to 2.1 wt %. In some embodiments, the alloys include Mo less than or equal to 2.2 wt %. In some embodiments, the alloys include Mo less than or equal to 2.1 wt %. In some embodiments, the alloys include Mo less than or equal to 2.2 wt %. In some embodiments, the alloys include Mo less than or equal to 2.1 wt %. In some embodiments, the alloys include Mo less than or equal to 2.2 wt %. In some embodiments, the alloys include Mo less than or equal to 2.1 wt %. In some embodiments, the alloys include Mo less than or equal to 2.2 wt %. In some embodiments, the alloys include Mo less than or equal to 2.1 wt %. In some embodiments, the alloys include Mo less than or equal to 2.2 wt %. In some embodiments, the alloys include Mo less than or equal to 2.1 wt %. In some embodiments, the alloys include Mo less than or equal to 2.2 wt %. In some embodiments, the alloys include Mo less than or equal to 2.1 wt %. In some embodiments, the alloys include Mo less than or equal to 2.2 wt %. In some embodiments, the alloys include Mo less than or equal to 2.1 wt %. In some embodiments, the alloys include Mo less than or equal to 2.2 wt %. In some embodiments, the alloys include Mo less than or equal to 2.1 wt %. In some embodiments, the alloys include Mo less than or equal to 2.2 wt %. In some embodiments, the alloys include Mo less than or equal to 2.1 wt %. In some embodiments, the alloys include Mo less than or equal to 2.2 wt %. In some embodiments, the alloys include Mo less than or equal to 2.1 wt %.

In some embodiments, the alloys include Mo greater than or equal to 2.0 wt %. In some embodiments, the alloys include Mo greater than or equal to 2.1 wt %. In some embodiments, the alloys include Mo greater than or equal to 2.2 wt %. In some embodiments, the alloys include Mo greater than or equal to 2.3 wt %. In some embodiments, the alloys include Mo greater than or equal to 2.4 wt %. In some embodiments, the alloys include Mo greater than or equal to 2.5 wt %. In some embodiments, the alloys include Mo greater than or equal to 2.6 wt %. In some embodiments, the alloys include Mo greater than or equal to 2.7 wt %. In some embodiments, the alloys include Mo greater than or equal to 2.8 wt %. In some embodiments, the alloys include Mo greater than or equal to 2.9 wt %.

In some variations, the iron-based alloys can include nitrogen (N). In various aspects, nitrogen provides for austenite formation (i.e. forming FCC) during nitriding, and corresponding hardening and mechanical strength. In various additional aspects, nitrogen can increase resistance to localized corrosion, especially in combination with molybdenum.

In some embodiments, the alloy includes N equal to or greater than 0.030 wt %. In some embodiments, the alloy includes N equal to or greater than 0.035 wt %. In some embodiments, the alloy includes N equal to or greater than 0.040 wt %. In some embodiments, the alloy includes N equal to or greater than 0.045 wt %. In some embodiments, the alloy includes N equal to or greater than 0.050 wt %. In some embodiments, the alloy includes N equal to or greater than 0.055 wt %. In some embodiments, the alloy includes N equal to or greater than 0.060 wt %. In some embodiments, the alloy includes N equal to or greater than 0.065 wt %. In some embodiments, the alloy includes N equal to or greater than 0.070 wt %. In some embodiments, the alloy includes N equal to or greater than 0.075 wt %. In some embodiments, the alloy includes N equal to or greater than 0.080 wt %. In some embodiments, the alloy includes N equal to or greater than 0.085 wt %. In some embodiments, the alloy includes N equal to or greater than 0.090 wt %. In some embodiments, the alloy includes N equal to or greater than 0.095 wt %. In some embodiments, the alloy includes N equal to or greater than 0.1 wt %. In some embodiments, the alloy includes N equal to or greater than 0.2 wt %. In some embodiments, the alloy includes N equal to or greater than 0.3 wt %. In some embodiments, the alloy includes N equal to or greater than 0.4 wt %. In some embodiments, the alloy includes N equal to or greater than 0.5 wt %. In some embodiments, the alloy includes N equal to or greater than 0.6 wt %. In some embodiments, the alloy includes N equal to or greater than 0.7 wt %. In some embodiments, the alloy includes N equal to or greater than 0.8 wt %. In some embodiments, the alloy includes N equal to or greater than 0.9 wt %. In some embodiments, the alloy includes N equal to or greater than 1.0 wt %. In some embodiments, the alloy includes N equal to or greater than 1.05 wt %. In some embodiments, the alloy includes N equal to or greater than 1.10 wt %. In some embodiments, the alloy includes N equal to or greater than 1.15 wt %. In some embodiments, the alloy includes N equal to or greater than 1.20 wt %. In some embodiments, the alloy includes N equal to or greater than 1.25 wt %. In some embodiments, the alloy includes N equal to or greater than 1.30 wt %. In some embodiments, the alloy includes N equal to or greater than 1.35 wt %. In some embodiments, the alloy includes N equal to or greater than 1.40 wt %. In some embodiments, the alloy includes N equal to or greater than 1.45 wt %. In some embodiments, the alloy includes N equal to or greater than 1.50 wt %. In some embodiments, the alloy includes N equal to or greater than 1.55 wt %. In some embodiments, the alloy includes N equal to or greater than 1.60 wt %. In some embodiments, the alloy includes N equal to or greater than 1.65 wt %.

In some embodiments, the alloy includes N equal to or greater than 1.70 wt %. In some embodiments, the alloy includes N equal to or greater than 1.75 wt %. In some embodiments, the alloy includes N equal to or greater than 1.80 wt %. In some embodiments, the alloy includes N equal to or greater than 1.85 wt %. In some embodiments, the alloy includes N equal to or greater than 1.90 wt %. In some embodiments, the alloy includes N equal to or greater than 1.95 wt %.

In some embodiments, the alloy includes N equal to or less than 2.00 wt %. In some embodiments, the alloy includes N equal to or less than 1.95 wt %. In some embodiments, the alloy includes N equal to or less than 1.90 wt %. In some embodiments, the alloy includes N equal to or less than 1.85 wt %. In some embodiments, the alloy includes N equal to or less than 1.80 wt %. In some embodiments, the alloy includes N equal to or less than 1.75 wt %. In some embodiments, the alloy includes N equal to or less than 1.70 wt %. In some embodiments, the alloy includes N equal to or less than 1.65 wt %. In some embodiments, the alloy includes N equal to or less than 1.60 wt %. In some embodiments, the alloy includes N equal to or less than 1.55 wt %. In some embodiments, the alloy includes N equal to or less than 1.50 wt %. In some embodiments, the alloy includes N equal to or less than 1.45 wt %. In some embodiments, the alloy includes N equal to or less than 1.40 wt %. In some embodiments, the alloy includes N equal to or less than 1.35 wt %. In some embodiments, the alloy includes N equal to or less than 1.30 wt %. In some embodiments, the alloy includes N equal to or less than 1.25 wt %. In some embodiments, the alloy includes N equal to or less than 1.20 wt %. In some embodiments, the alloy includes N equal to or less than 1.15 wt %. In some embodiments, the alloy includes N equal to or less than 1.10 wt %. In some embodiments, the alloy includes N equal to or less than 1.05 wt %. In some embodiments, the alloy includes N equal to or less than 1.00 wt %. In some embodiments, the alloy includes N equal to or less than 0.95 wt %. In some embodiments, the alloy includes N equal to or less than 0.90 wt %. In some embodiments, the alloy includes N equal to or less than 0.85 wt %. In some embodiments, the alloy includes N equal to or less than 0.80 wt %. In some embodiments, the alloy includes N equal to or less than 0.75 wt %. In some embodiments, the alloy includes N equal to or less than 0.70 wt %. In some embodiments, the alloy includes N equal to or less than 0.65 wt %. In some embodiments, the alloy includes N equal to or less than 0.60 wt %. In some embodiments, the alloy includes N equal to or less than 0.55 wt %. In some embodiments, the alloy includes N equal to or less than 0.50 wt %. In some embodiments, the alloy includes N equal to or less than 0.45 wt %. In some embodiments, the alloy includes N equal to or less than 0.40 wt %. In some embodiments, the alloy includes N equal to or less than 0.35 wt %. In some embodiments, the alloy includes N equal to or less than 0.30 wt %. In some embodiments, the alloy includes N equal to or less than 0.25 wt %. In some embodiments, the alloy includes N equal to or less than 0.20 wt %. In some embodiments, the alloy includes N equal to or less than 0.15 wt %. In some embodiments, the alloy includes N equal to or less than 0.10 wt %. In some embodiments, the alloy includes N equal to or less than 0.05 wt %. In some embodiments, the alloy includes N equal to or less than 0.045 wt %. In some embodiments, the alloy includes N equal to or less than 0.04 wt %. In some embodiments, the alloy includes N equal to or less than 0.035 wt %.

In some embodiments, the iron-based alloys can have 0.03 to 1.5 wt % nitrogen (N). It will be appreciated by one of the skilled in the art that the estimated maximum solubility may vary with the ranges of the temperature and N₂ gas pressure and the alloy composition.

The iron-based alloy can include copper (Cu). In some embodiments, the alloys include Cu less than or equal to 3.0 wt %. In some embodiments, the alloys include Cu less than or equal to 2.5 wt %. In some embodiments, the alloys include Cu less than or equal to 2.0 wt %. In some embodiments, the alloys include Cu less than or equal to 1.5 wt %. In some embodiments, the alloys include Cu less than or equal to 1.0 wt %. In some embodiments, the alloys include Cu less than or equal to 0.5 wt %. In some embodiments, the alloys include Cu less than or equal to 0.4 wt %. In some embodiments, the alloys include Cu less than or equal to 0.3 wt %. In some embodiments, the alloys include Cu less than or equal to 0.2 wt %. In some embodiments, the alloys include Cu less than or equal to 0.1 wt %.

Nitrided 301 Stainless Steel

In some variations, the disclosure provides iron-based alloys including chromium (Cr) ranging from 15.0 wt % to 19.0 wt %, nickel (Ni) ranging from 5.0 wt % to 9.0 wt %, manganese (Mn) less than or equal to 3.0 wt %, nitrogen (N) from 0.02 wt % to 1.5 wt %, less than or equal to 1.0 wt % silicon (Si), and carbon (C) less than or equal to 0.15 wt %. In some variations, disclosure provides iron-based alloys including chromium (Cr) ranging from 16.0 wt % to 18.0 wt %, nickel (Ni) ranging from 6.0 wt % to 8.0 wt %, manganese (Mn) less than or equal to 2.0 wt %, nitrogen (N) from 0.02 wt % to 1.5 wt %, less than or equal to 1.0 wt % silicon (Si), and carbon (C) less than or equal to 0.15 wt %.

In some embodiments, the iron-based alloys include Cr from 15.0 to 19.0 wt %. In some embodiments, the iron-based alloys include Cr from 16.0 to 18.0 wt %. In some embodiments, the alloys include Cr less than 19.0 wt %. In some embodiments, the alloys include Cr less than 18.5 wt %. In some embodiments, the alloys include Cr less than 18.0 wt %. In some embodiments, the alloys include Cr less than 17.5 wt %. In some embodiments, the alloys include Cr less than 17.0 wt %. In some embodiments, the alloys include Cr less than 16.5 wt %. In some embodiments, the alloys include Cr less than 16.0 wt %. In some embodiments, the alloys include Cr less than 15.5 wt %. In some embodiments, the alloys include Cr in an amount of at least 15.0 wt %. In some embodiments, the alloys include Cr an amount of at least 15.5 wt %. In some embodiments, the alloys include Cr an amount of at least 16.0 wt %. In some embodiments, the alloys include Cr an amount of at least 16.5 wt %. In some embodiments, the alloys include Cr an amount of at least 17.0 wt %. In some embodiments, the alloys include Cr an amount of at least 17.5 wt %. In some embodiments, the alloys include Cr an amount of at least 18.0 wt %. In some embodiments, the alloys include Cr an amount of at least 18.5 wt %.

In some embodiments, the iron-based alloys include nickel (Ni) from 5.0 to 9.0 wt %. In some embodiments, the iron-based alloys include nickel (Ni) from 6.0 to 8.0 wt %. In some embodiments, the alloys include Ni equal to or less than 9.0 wt %. In some embodiments, the alloys include Ni equal to or less than 8.5 wt %. In some embodiments, the alloys include Ni equal to or less than 8.0 wt %. In some embodiments, the alloys include Ni equal to or less than 7.5 wt %. In some embodiments, the alloys include Ni equal to or less than 7.0 wt %. In some embodiments, the alloys include Ni equal to or less than 6.5 wt %. In some embodiments, the alloys include Ni equal to or greater than 5.0 wt %. In some embodiments, the alloys include Ni equal to or greater than 5.5 wt %. In some embodiments, the alloys include Ni equal to or greater than 6.0 wt %. In some embodiments, the alloys include Ni equal to or greater than 6.5 wt %. In some embodiments, the alloys include Ni equal to or greater than 7.0 wt %. In some embodiments, the alloys include Ni equal to or greater than 7.5 wt %. In some embodiments, the alloys include Ni equal to or greater than 8.0 wt %. In some embodiments, the alloys include Ni equal to or greater than 8.5 wt %.

In some embodiments, the iron-based alloys include manganese (Mn) less than or equal to 3.0 wt %. In some embodiments, the alloys include less than or equal to 2.5 wt % Mn. In some embodiments, the alloys include less than or equal to 2.0 wt % Mn. In some embodiments, the alloys include less than or equal to 1.5 wt % Mn. In some embodiments, the alloys include less than or equal to 1.0 wt % Mn. In some embodiments, the alloys include less than or equal to 0.5 wt % Mn. In some embodiments, the alloys include less than or equal to 0.4 wt % Mn. In some embodiments, the alloys include less than or equal to 0.3 wt % Mn. In some embodiments, the alloys include less than or equal to 0.2 wt % Mn. In some embodiments, the alloys include less than or equal to 0.1 wt % Mn.

In some embodiments, the iron-based alloys include silicon (Si) less than or equal to 1.0 wt %. In some embodiments, the alloys include Si in an amount less than or equal to 0.95 wt %. In some embodiments, the alloys include Si in an amount less than or equal to 0.90 wt %. In some embodiments, the alloys include Si in an amount less than or equal to 0.85 wt %. In some embodiments, the alloys include Si in an amount less than or equal to 0.80 wt %. In some embodiments, the alloys include Si in an amount less than or equal to 0.75 wt %. In some embodiments, the alloys include Si in an amount less than or equal to 0.70 wt %. In some embodiments, the alloys include Si in an amount less than or equal to 0.65 wt %. In some embodiments, the alloys include Si in an amount less than or equal to 0.60 wt %. In some embodiments, the alloys include Si in an amount less than or equal to 0.55 wt %. In some embodiments, the alloys include Si in an amount less than or equal to 0.50 wt %. In some embodiments, the alloys include Si in an amount less than or equal to 0.40 wt %. In some embodiments, the alloys include Si in an amount less than or equal to 0.30 wt %. In some embodiments, the alloys include Si in an amount less than or equal to 0.20 wt %. In some embodiments, the alloys include Si in an amount less than or equal to 0.10 wt %.

In some variations, the iron-based alloys can include nitrogen (N). In various aspects, nitrogen provides for austenite formation (i.e. forming FCC) during nitriding, and corresponding hardening and mechanical strength. In various additional aspects, nitrogen can increase resistance to localized corrosion, especially in combination with molybdenum.

In some variations, the iron-based alloys can include nitrogen (N). In various aspects, nitrogen provides for austenite formation (i.e. forming FCC) during nitriding, and corresponding hardening and mechanical strength. In various additional aspects, nitrogen can increase resistance to localized corrosion, especially in combination with molybdenum.

The iron-based alloys can have 0.02 to 1.5 wt % nitrogen (N). In some embodiments, the alloy includes N equal to or greater than 0.020 wt %. In some embodiments, the alloy includes N equal to or greater than 0.025 wt %. In some embodiments, the alloy includes N equal to or greater than 0.030 wt %. In some embodiments, the alloy includes N equal to or greater than 0.035 wt %. In some embodiments, the alloy includes N equal to or greater than 0.040 wt %. In some embodiments, the alloy includes N equal to or greater than 0.045 wt %. In some embodiments, the alloy includes N equal to or greater than 0.050 wt %. In some embodiments, the alloy includes N equal to or greater than 0.055 wt %. In some embodiments, the alloy includes N equal to or greater than 0.060 wt %. In some embodiments, the alloy includes N equal to or greater than 0.065 wt %. In some embodiments, the alloy includes N equal to or greater than 0.070 wt %. In some embodiments, the alloy includes N equal to or greater than 0.075 wt %. In some embodiments, the alloy includes N equal to or greater than 0.080 wt %. In some embodiments, the alloy includes N equal to or greater than 0.085 wt %. In some embodiments, the alloy includes N equal to or greater than 0.090 wt %. In some embodiments, the alloy includes N equal to or greater than 0.095 wt %. In some embodiments, the alloy includes N equal to or greater than 0.1 wt %. In some embodiments, the alloy includes N equal to or greater than 0.2 wt %. In some embodiments, the alloy includes N equal to or greater than 0.3 wt %. In some embodiments, the alloy includes N equal to or greater than 0.4 wt %. In some embodiments, the alloy includes N equal to or greater than 0.5 wt %. In some embodiments, the alloy includes N equal to or greater than 0.6 wt %. In some embodiments, the alloy includes N equal to or greater than 0.7 wt %. In some embodiments, the alloy includes N equal to or greater than 0.8 wt %. In some embodiments, the alloy includes N equal to or greater than 0.9 wt %. In some embodiments, the alloy includes N equal to or greater than 1.0 wt %. In some embodiments, the alloy includes N equal to or greater than 1.05 wt %. In some embodiments, the alloy includes N equal to or greater than 1.10 wt %. In some embodiments, the alloy includes N equal to or greater than 1.15 wt %. In some embodiments, the alloy includes N equal to or greater than 1.20 wt %. In some embodiments, the alloy includes N equal to or greater than 1.25 wt %. In some embodiments, the alloy includes N equal to or greater than 1.30 wt %. In some embodiments, the alloy includes N equal to or greater than 1.35 wt %. In some embodiments, the alloy includes N equal to or greater than 1.40 wt %. In some embodiments, the alloy includes N equal to or greater than 1.45 wt %.

In some embodiments, the alloy includes N equal to or less than 1.50 wt %. In some embodiments, the alloy includes N equal to or less than 1.45 wt %. In some embodiments, the alloy includes N equal to or less than 1.40 wt %. In some embodiments, the alloy includes N equal to or less than 1.35 wt %. In some embodiments, the alloy includes N equal to or less than 1.30 wt %. In some embodiments, the alloy includes N equal to or less than 1.25 wt %. In some embodiments, the alloy includes N equal to or less than 1.20 wt %. In some embodiments, the alloy includes N equal to or less than 1.15 wt %. In some embodiments, the alloy includes N equal to or less than 1.10 wt %. In some embodiments, the alloy includes N equal to or less than 1.05 wt %. In some embodiments, the alloy includes N equal to or less than 1.00 wt %. In some embodiments, the alloy includes N equal to or less than 0.95 wt %. In some embodiments, the alloy includes N equal to or less than 0.90 wt %. In some embodiments, the alloy includes N equal to or less than 0.85 wt %. In some embodiments, the alloy includes N equal to or less than 0.80 wt %. In some embodiments, the alloy includes N equal to or less than 0.75 wt %. In some embodiments, the alloy includes N equal to or less than 0.70 wt %. In some embodiments, the alloy includes N equal to or less than 0.65 wt %. In some embodiments, the alloy includes N equal to or less than 0.60 wt %. In some embodiments, the alloy includes N equal to or less than 0.55 wt %. In some embodiments, the alloy includes N equal to or less than 0.50 wt %. In some embodiments, the alloy includes N equal to or less than 0.45 wt %. In some embodiments, the alloy includes N equal to or less than 0.40 wt %. In some embodiments, the alloy includes N equal to or less than 0.35 wt %. In some embodiments, the alloy includes N equal to or less than 0.30 wt %. In some embodiments, the alloy includes N equal to or less than 0.25 wt %. In some embodiments, the alloy includes N equal to or less than 0.20 wt %. In some embodiments, the alloy includes N equal to or less than 0.15 wt %. In some embodiments, the alloy includes N equal to or less than 0.10 wt %. In some embodiments, the alloy includes N equal to or less than 0.05 wt %. In some embodiments, the alloy includes N equal to or less than 0.045 wt %. In some embodiments, the alloy includes N equal to or less than 0.04 wt %. In some embodiments, the alloy includes N equal to or less than 0.035 wt %. In some embodiments, the alloy includes N equal to or less than 0.03 wt %. In some embodiments, the alloy includes N equal to or less than 0.025 wt %.

It will be appreciated by one of the skilled in the art that the estimated maximum solubility may vary with the ranges of the temperature and N₂ gas pressure and the alloy composition.

The iron-based alloy can include copper (Cu). In some embodiments, the alloys include Cu less than or equal to 3.0 wt %. In some embodiments, the alloys include Cu less than or equal to 2.5 wt %. In some embodiments, the alloys include Cu less than or equal to 2.0 wt %. In some embodiments, the alloys include Cu less than or equal to 1.5 wt %. In some embodiments, the alloys include Cu less than or equal to 1.0 wt %. In some embodiments, the alloys include Cu less than or equal to 0.5 wt %. In some embodiments, the alloys include Cu less than or equal to 0.4 wt %. In some embodiments, the alloys include Cu less than or equal to 0.3 wt %. In some embodiments, the alloys include Cu less than or equal to 0.2 wt %. In some embodiments, the alloys include Cu less than or equal to 0.1 wt %.

All alloy variations described herein. In some variations, the iron-based alloys can include Sulfur (S). In some variations, the iron-based alloys may include S in an amount less than or equal to 0.03 wt %. In some embodiments, the alloys include S in an amount less than or equal to 0.02 wt %. In some embodiments, the alloys include S in an amount less than or equal to 0.01 wt %. In some embodiments, the alloys include S in an amount less than or equal to 0.005 wt %. In some embodiments, the alloys include S in an amount less than or equal to 0.001 wt %.

In some variations, the iron-based alloys may include Phosphorus (P).

In some embodiments, the iron-based alloys may also include P less than or equal to 0.05 wt %. In some embodiments, the iron-based alloys may also include P less than or equal to 0.04 wt %. In some embodiments, the alloys include P less than or equal to 0.03 wt %. In some embodiments, the alloys include P less than or equal to 0.02 wt %. In some embodiments, the alloys include P less than or equal to 0.01 wt %.

The alloys can be described by various wt % of elements, as well as specific properties. In various descriptions of the alloys described herein, it will be understood that the wt % balance of alloys is Fe and trace elements. In various embodiments, a trace elements can be no greater than 0.05 wt % of any one additional element (i.e., a single trace element), and no greater than 0.10 wt % total of all additional elements (i.e., total trace element).

In some embodiments, the alloys include other trace elements in an amount less than or equal to 0.10 wt %. In some embodiments, the alloys include other trace elements in an amount less than or equal to 0.09 wt %. In some embodiments, the alloys include other trace elements in an amount less than or equal to 0.08 wt %. In some embodiments, the alloys include other trace elements in an amount less than or equal to 0.07 wt %. In some embodiments, the alloys include other trace elements in an amount less than or equal to 0.06 wt %. In some embodiments, the alloys include other trace elements in an amount less than or equal to 0.05 wt %. In some embodiments, the alloys include other trace elements in an amount less than or equal to 0.04 wt %. In some embodiments, the alloys include other trace elements in an amount less than or equal to 0.03 wt %. In some embodiments, the alloys include other trace elements in an amount less than or equal to 0.02 wt %. In some embodiments, the alloys include other trace elements in an amount less than or equal to 0.01 wt %. Trace elements can include incidental elements that can be present, for example, as a byproduct of processing and manufacturing.

Nitrided 3xx Stainless Steels

In some variations, the disclosure provides iron-based alloys including chromium (Cr) ranging from 16.0 wt % to 21.0 wt %, nickel (Ni) ranging from 8.0 wt % to 13.0 wt %, manganese (Mn) less than or equal to 4.5 wt %, nitrogen (N) from 0.035 wt % to 1.5 wt %, silicon (Si) equal to or greater than 0.03 wt % and less than or equal to 1.0 wt %, carbon (C) equal to or greater than 0.02 wt % but less than or equal to 0.15 wt %, and sulfur (S) less than or equal to 0.03 wt %.

The iron-based alloy can include chromium (Cr). In some variations, increasing Cr resists corrosion in the alloy. In some embodiments, the iron-based alloys include Cr from 16.0 to 21.0 wt %. In some embodiments, the alloys include Cr equal to or less than 21.0 wt %. In some embodiments, the alloys include Cr equal to or less than 20.0 wt %. In some embodiments, the alloys include Cr equal to or less than 19.5 wt %. In some embodiments, the alloys include Cr equal to or less than 19.0 wt %. In some embodiments, the alloys include Cr equal to or less than 18.5 wt %. In some embodiments, the alloys include Cr equal to or less than 18.0 wt %. In some embodiments, the alloys include Cr equal to or less than 17.5 wt %.

In some embodiments, the alloys include Cr at least 16.0 wt %. In some embodiments, the alloys include Cr at least 17.0 wt %. In some embodiments, the alloys include Cr at least 17.5 wt %. In some embodiments, the alloys include Cr at least 18.0 wt %. In some embodiments, the alloys include Cr at least 18.5 wt %. In some embodiments, the alloys include Cr at least 19.0 wt %. In some embodiments, the alloys include Cr at least 19.5 wt %. In some embodiments, the alloys include Cr at least 20.0 wt %. In some embodiments, the alloys include Cr at least 20.5 wt %.

In some embodiments, the iron-based alloys include nickel (Ni) from 8.0 to 13.0 wt %. In some embodiments, the alloys include Ni equal to or less than 13.0 wt %. In some embodiments, the alloys include Ni equal to or less than 12.5 wt %. In some embodiments, the alloys include Ni equal to or less than 12.0 wt %. In some embodiments, the alloys include Ni equal to or less than 11.5 wt %. In some embodiments, the alloys include Ni equal to or less than 11.0 wt %. In some embodiments, the alloys include Ni equal to or less than 10.5 wt %. In some embodiments, the alloys include Ni equal to or less than 10.0 wt %. In some embodiments, the alloys include Ni equal to or less than 9.5 wt %. In some embodiments, the alloys include Ni equal to or less than 9.0 wt %. In some embodiments, the alloys include Ni equal to or less than 8.5 wt.

In some embodiments, the alloys include Ni equal to or greater than 8.0 wt %. In some embodiments, the alloys include Ni equal to or greater than 8.5 wt %. In some embodiments, the alloys include Ni equal to or greater than 9.0 wt %. In some embodiments, the alloys include Ni equal to or greater than 9.5 wt %. In some embodiments, the alloys include Ni equal to or greater than 10.0 wt %. In some embodiments, the alloys include Ni equal to or greater than 10.5 wt %. In some embodiments, the alloys include Ni equal to or greater than 11.0 wt %. In some embodiments, the alloys include Ni equal to or greater than 11.5 wt %. In some embodiments, the alloys include Ni equal to or greater than 12.0 wt %. In some embodiments, the alloys include Ni equal to or greater than 12.5 wt %.

In some embodiments, the iron-based alloys include manganese (Mn) less than or equal to 6.0 wt %. In some embodiments, the iron-based alloys include manganese (Mn) less than or equal to 5.5 wt %. In some embodiments, the iron-based alloys include manganese (Mn) less than or equal to 5.0 wt %. In some embodiments, the iron-based alloys include manganese (Mn) less than or equal to 4.5 wt %. In some embodiments, the iron-based alloys include manganese (Mn) less than or equal to 4.0 wt %. In some embodiments, the iron-based alloys include manganese (Mn) less than or equal to 3.5 wt %. In some embodiments, the iron-based alloys include manganese (Mn) less than or equal to 3.0 wt %. In some embodiments, the iron-based alloys include manganese (Mn) less than or equal to 2.5 wt %. In some embodiments, the iron-based alloys include manganese (Mn) less than or equal to 2.0 wt %. In some embodiments, the iron-based alloys include manganese (Mn) less than or equal to 1.5 wt %. In some embodiments, the iron-based alloys include manganese (Mn) less than or equal to 1.0 wt %. In some embodiments, the iron-based alloys include manganese (Mn) less than or equal to 0.5 wt %.

In some variations, the alloy includes Mn in an amount of at least 0.2 wt %. In some variations, the alloy includes Mn in an amount of at least 0.5 wt %. In some variations, the alloy includes Mn in an amount of at least 1.0 wt %. In some variations, the alloy includes Mn in an amount of at least 2.0 wt %. In some variations, the alloy includes Mn in an amount of at least 2.5 wt %. In some variations, the alloy includes Mn in an amount of at least 3.0 wt %. In some variations, the alloy includes Mn in an amount of at least 3.5 wt %. In some variations, the alloy includes Mn in an amount of at least 4.0 wt %.

In some embodiments, the alloys include Si in an amount at least 0.03 wt %.

In some variations, the iron-based alloys can include nitrogen (N). In various aspects, nitrogen provides for austenite formation (i.e. forming FCC) during nitriding, and corresponding hardening and mechanical strength. In various additional aspects, nitrogen can increase resistance to localized corrosion, especially in combination with molybdenum.

The iron-based alloys can have 0.035 to 1.5 wt % nitrogen (N). In some embodiments, the alloy includes N equal to or greater than 0.035 wt %. In some embodiments, the alloy includes N equal to or greater than 0.040 wt %. In some embodiments, the alloy includes N equal to or greater than 0.045 wt %. In some embodiments, the alloy includes N equal to or greater than 0.050 wt %. In some embodiments, the alloy includes N equal to or greater than 0.055 wt %. In some embodiments, the alloy includes N equal to or greater than 0.060 wt %. In some embodiments, the alloy includes N equal to or greater than 0.065 wt %. In some embodiments, the alloy includes N equal to or greater than 0.070 wt %. In some embodiments, the alloy includes N equal to or greater than 0.075 wt %. In some embodiments, the alloy includes N equal to or greater than 0.080 wt %. In some embodiments, the alloy includes N equal to or greater than 0.085 wt %. In some embodiments, the alloy includes N equal to or greater than 0.090 wt %. In some embodiments, the alloy includes N equal to or greater than 0.095 wt %. In some embodiments, the alloy includes N equal to or greater than 0.1 wt %. In some embodiments, the alloy includes N equal to or greater than 0.2 wt %. In some embodiments, the alloy includes N equal to or greater than 0.3 wt %. In some embodiments, the alloy includes N equal to or greater than 0.4 wt %. In some embodiments, the alloy includes N equal to or greater than 0.5 wt %. In some embodiments, the alloy includes N equal to or greater than 0.6 wt %. In some embodiments, the alloy includes N equal to or greater than 0.7 wt %. In some embodiments, the alloy includes N equal to or greater than 0.8 wt %. In some embodiments, the alloy includes N equal to or greater than 0.9 wt %. In some embodiments, the alloy includes N equal to or greater than 1.0 wt %. In some embodiments, the alloy includes N equal to or greater than 1.05 wt %. In some embodiments, the alloy includes N equal to or greater than 1.10 wt %. In some embodiments, the alloy includes N equal to or greater than 1.15 wt %. In some embodiments, the alloy includes N equal to or greater than 1.20 wt %. In some embodiments, the alloy includes N equal to or greater than 1.25 wt %. In some embodiments, the alloy includes N equal to or greater than 1.30 wt %. In some embodiments, the alloy includes N equal to or greater than 1.35 wt %. In some embodiments, the alloy includes N equal to or greater than 1.40 wt %. In some embodiments, the alloy includes N equal to or greater than 1.45 wt %.

In some embodiments, the alloy includes N less than or equal to 1.50 wt %. In some embodiments, the alloy includes N less than or equal to 1.45 wt %. In some embodiments, the alloy includes N less than or equal to 1.40 wt %. In some embodiments, the alloy includes N less than or equal to 1.35 wt %. In some embodiments, the alloy includes N less than or equal to 1.30 wt %. In some embodiments, the alloy includes N less than or equal to 1.25 wt %. In some embodiments, the alloy includes N less than or equal to 1.20 wt %. In some embodiments, the alloy includes N less than or equal to 1.15 wt %. In some embodiments, the alloy includes N less than or equal to 1.10 wt %. In some embodiments, the alloy includes N less than or equal to 1.05 wt %. In some embodiments, the alloy includes N less than or equal to 1.00 wt %. In some embodiments, the alloy includes N less than or equal to 0.95 wt %. In some embodiments, the alloy includes N less than or equal to 0.90 wt %. In some embodiments, the alloy includes N less than or equal to 0.85 wt %. In some embodiments, the alloy includes N less than or equal to 0.80 wt %. In some embodiments, the alloy includes N less than or equal to 0.75 wt %. In some embodiments, the alloy includes N less than or equal to 0.70 wt %. In some embodiments, the alloy includes N less than or equal to 0.65 wt %. In some embodiments, the alloy includes N less than or equal to 0.60 wt %. In some embodiments, the alloy includes N less than or equal to 0.55 wt %. In some embodiments, the alloy includes N less than or equal to 0.50 wt %. In some embodiments, the alloy includes N less than or equal to 0.45 wt %. In some embodiments, the alloy includes N less than or equal to 0.40 wt %. In some embodiments, the alloy includes N less than or equal to 0.35 wt %. In some embodiments, the alloy includes N less than or equal to 0.30 wt %. In some embodiments, the alloy includes N less than or equal to 0.25 wt %. In some embodiments, the alloy includes N less than or equal to 0.20 wt %. In some embodiments, the alloy includes N less than or equal to 0.15 wt %. In some embodiments, the alloy includes N less than or equal to 0.10 wt %. In some embodiments, the alloy includes N less than or equal to 0.05 wt %. In some embodiments, the alloy includes N less than or equal to 0.045 wt %. In some embodiments, the alloy includes N less than or equal to 0.04 wt %. In some embodiments, the alloy includes N less than or equal to 0.035 wt %. In some embodiments, the alloy includes N less than or equal to 0.03 wt %. In some embodiments, the alloy includes N less than or equal to 0.025 wt %.

It will be appreciated by one of the skilled in the art that the estimated maximum solubility may vary with the ranges of the temperature and N₂ gas pressure and the alloy composition.

The iron-based alloy can include molybdenum (Mo) less than or equal to 4 wt %. In some aspects, the amount of Mo is low because it increases the necessary nitrogen gas pressure during nitriding for an equivalent alloy nitrogen content.

The iron-based alloy can include sulfur (S) less than or equal to 0.03 wt %. Sulfur is an inevitable impurity.

It will be appreciated by those skilled in the art that corrosion resistance may vary with composition, nitrogen content, and polishing condition.

Tensile Properties

The tensile properties of the alloys can be measured per ASTM, which covers the testing apparatus, test specimens, and testing procedure for tensile testing.

In variations of the disclosure, the tensile properties of the alloys may vary with alloy composition and nitriding parameters, such temperatures and nitrogen gas pressures. In variations of the disclosure, the tensile properties may also vary with cold roll reduction % or annealed condition.

Hardness

In variations of the disclosure, the hardness of the nitrided alloys may vary with alloy composition and nitriding parameters, such temperatures and nitrogen gas pressures. Hardness measurement may be performed by Vickers microhardness indentation.

Corrosion Resistance

The corrosion resistance of the nitrided alloys can be measured as a lower passive current density or higher pitting potential.

It will be appreciated by those skilled in the art that corrosion resistance may vary with composition, nitrogen content, and polishing condition.

Magnetic Permeability

Magnetic permeability can be measured by a permeability meter.

The disclosed Fe-based alloys and methods can be used in the fabrication of electronic devices. An electronic device herein can refer to any electronic device known in the art. For example, such devices can include wearable devices such as a watch (e.g., an AppleWatch®). Devices can also be a telephone such a mobile phone (e.g., an iPhone®) a land-line phone, or any communication device (e.g., an electronic email sending/receiving device). The alloys can be a part of a display, such as a digital display, a TV monitor, an electronic-book reader, a portable web-browser (e.g., iPad®), and a computer monitor. The alloys can also be an entertainment device, including a portable DVD player, conventional DVD player, Blue-Ray disk player, video game console, music player, such as a portable music player (e.g., iPod®), etc. The alloys can also be a part of a device that provides control, such as controlling the streaming of images, videos, sounds (e.g., Apple TV®), or can be a remote control for an electronic device. The alloys can be a part of a computer or its accessories, such as the hard drive tower housing or casing.

### EXAMPLES

The following non-limiting examples are included as illustrations of the disclosure.

### Example 1: 304N and 304LN Stainless Steels

Table 1 lists the alloy composition for 304N and 304LN stainless steels. 304N SS represents nitrided stainless steels with low carbon less than or equal to 0.08 wt %, while 304LN SS represents nitrided stainless steels with low carbon less than or equal to 0.03 wt %. The disclosed 304N SS and 304LN SS alloys have different values for Ni from the conventional 304 stainless steels. For example, the conventional 304 stainless steels include 8 to 12 wt % Ni.

TABLE 1
304N and 304LN Stainless Steels

| | 304N SS | 304LN SS |
|---|---|---|
| C (maximum wt %) | 0.08 | 0.03 |

| | |
|---|---|
| Cr (range wt %) | 18.00-20.00 |
| Ni (range wt %) | 8.00-12.00 |
| Mn (maximum wt %) | 2.00 |
| Si (maximum wt %) | 0.75 |
| N (maximum wt %) | 1.06 |

The solubility of nitrogen in the 304 stainless steel varies with nitriding conditions, such as temperature and gas pressure. The estimated maximum solubility of nitrogen for the 304 stainless steel was determined to be 1.06 wt % by simulations for a particular alloy composition under various processing conditions including temperatures and gas pressures using software, such as ThermoCalc and Diffusion Module (DICTRA).

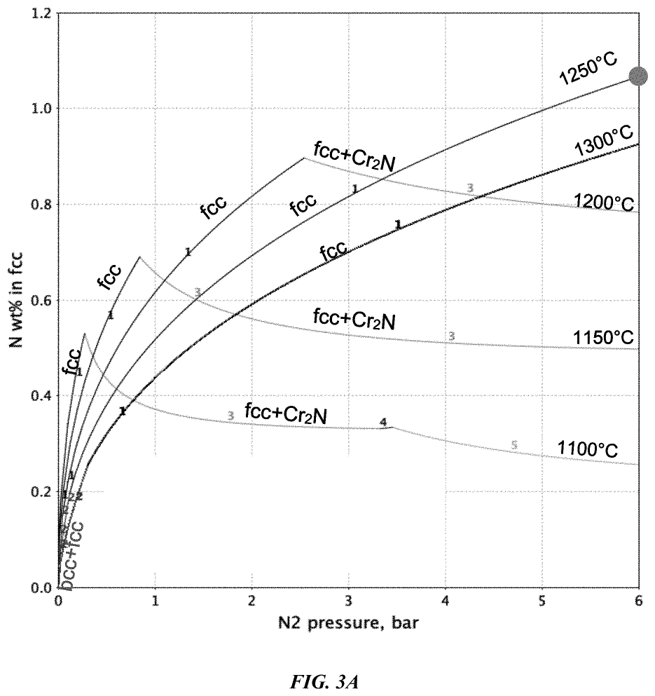

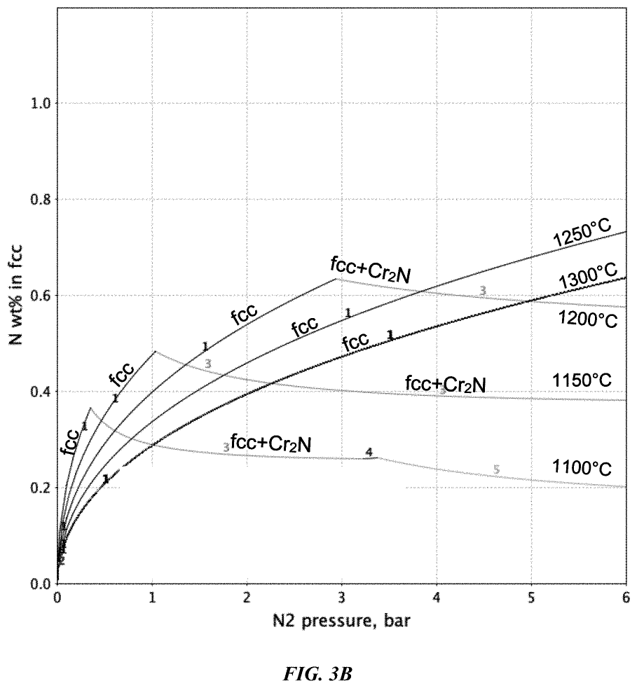

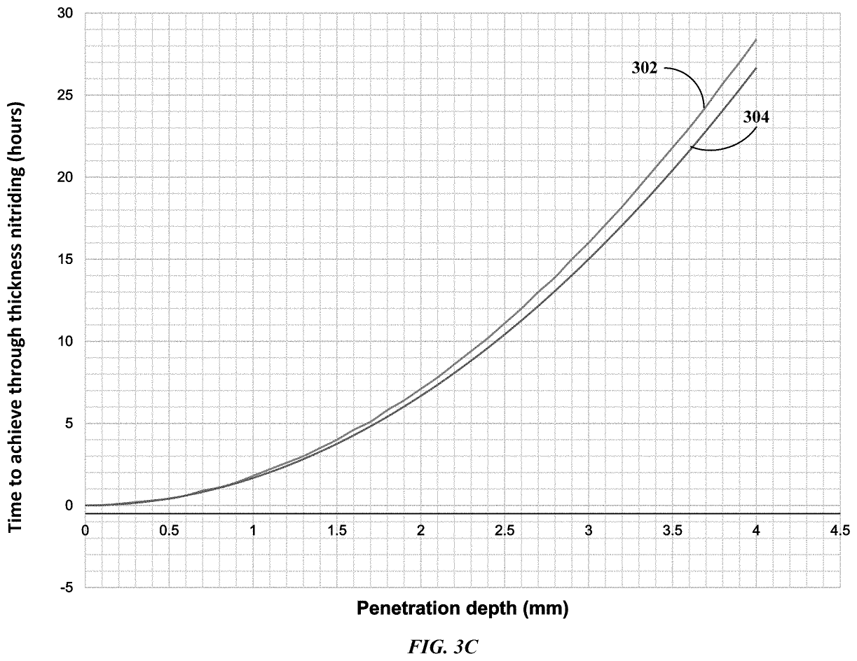

FIG. 3A illustrates nitrogen solubility versus N₂ gas pressure at various elevated temperatures for an example 304L alloy (Fe-20Cr-8Ni-1.9Mn-0.4Si-0.02C-0.1N) in accordance with embodiments of the disclosure. As shown in FIG. 3A, the N wt % in FCC depended upon N₂ gas pressure. The BCC phase was present at high temperatures from 1100° C. to 1300° C. When the N₂ gas pressure was lower than 0.3 bars and the N wt % in FCC was less than 0.23, a mixture of BCC and FCC was present for the Fe-20Cr-8Ni-1.9Mn-0.4Si-0.02C-0.1N alloy. When the N₂ gas pressure was higher than 0.3 bars and the N wt % in FCC was equal to or larger than 0.23, there was only FCC present.

Also, the estimated maximum solubility for N in FCC was found for the Fe-20Cr-8Ni-1.9Mn-0.4Si-0.02C-0.1N alloy. Further, the N wt % in FCC varied with N₂ gas pressures and temperatures. At temperatures 1250° C. and 1300° C., the N solubility in FCC increased with the N₂ gas pressure. However, at temperatures 1100° C. and 1150° C., the N solubility in FCC increased with the N₂ gas pressure at N₂ gas pressure up to about 0.5 bars or 1 bar, respectively, and then decreased with the N₂ gas pressure up to 6 bars. The estimated maximum solubility for N in FCC was 1.06 wt % achieved at 6 bars and 1250° C. in the temperature range from 1100° C. to 1300° C. and the N₂ gas pressure from 0 to 6 bars for the Fe-20Cr-8Ni-1.9Mn-0.4Si-0.02C-0.1N alloy.

FIG. 3B illustrates nitrogen solubility versus N₂ pressure at various elevated temperatures for an example 304L alloy (Fe-18Cr-10Ni-1.9Mn-0.75Si-0.02C-0.1N) in accordance with embodiments of the disclosure. As shown in FIG. 3B, the estimated minimum solubility for N in the 304L alloy was found for the Fe-18Cr-10Ni-1.9Mn-0.75Si-0.02C-0.1N alloy. The BCC phase was absent at high temperatures from 1100° C. to 1300° C. Also, the N wt % in FCC varied with N₂ gas pressures and temperatures. At temperatures 1250° C. and 1300° C., the N solubility in FCC increased with the N₂ gas pressure. However, at temperatures 1100° C. and 1150° C., the N solubility in FCC increased with the N₂ gas pressure at N₂ gas pressure up to about 0.5 bars or 1 bar, respectively, and then decreased with the N₂ gas pressure up to 6 bars. The solubility for N in FCC was about 0.72 wt % achieved at 6 bars and 1250° C. in the temperature range from 1100° C. to 1300° C. and the N₂ gas pressure from 0 to 6 bars for the Fe-20Cr-8Ni-1.9Mn-0.4Si-0.02C-0.1N alloy.

Increasing nitriding duration or time may improve hardness uniformity. A shorter nitriding time may produce a harder surface with a softer core. FIG. 3C illustrates penetration depth versus nitriding time for a 304L alloy in accordance with embodiments of the disclosure. As shown in FIG. 3C, curve 302 represents nitriding at 1150° C. and a N₂ gas pressure of 0.87 bar, and curve 304 represents nitriding at 1170° C. and a N₂ gas pressure of 1.35 bar. The penetration depth increases with the nitriding time as shown for both curves 302 and 304. Also, the lower temperature of 1150° C. and a lower N₂ gas pressure of 0.87 bar yielded higher penetration than the higher temperature of 1170° C. and a higher gas pressure of 1.35 bar.

It will be appreciated by one of the skilled in the art that the estimated maximum solubility of N in the alloy may vary with the ranges of the temperature and N₂ gas pressure and the alloy composition.

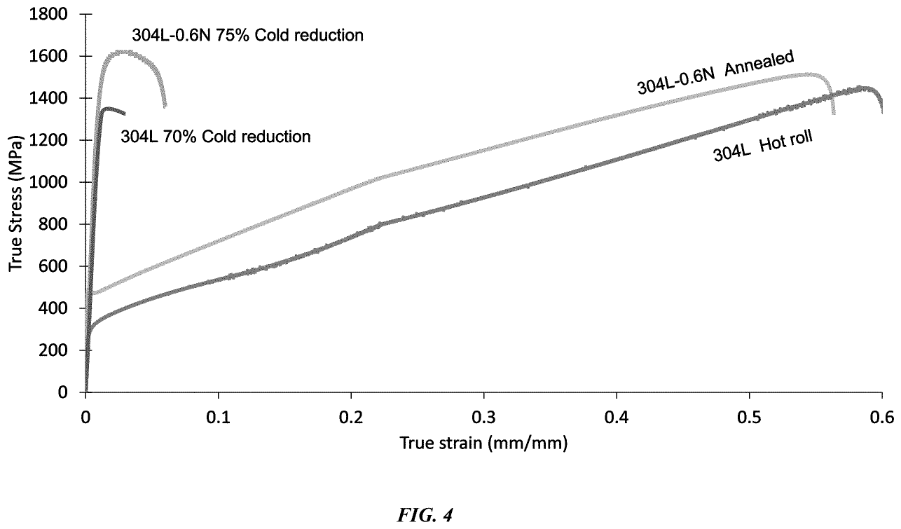

FIG. 4 illustrates true stress versus true strain curve for the 304L and 304LN alloys in accordance with embodiments of the disclosure. As shown in FIG. 4, the ultimate strength for sample alloy 304L-0.6N 75% cold reduction was higher than the sample alloy 304L 70% cold reduction. Also, the 304L-0.6N annealed sample alloy had higher ultimate strength than the sample alloy 304L hot roll. The results of FIG. 4 are summarized in Table 2.

Table 2 lists comparisons of properties of 304LN with 304L stainless steels. As shown, the ultimate strength increased from 1325 MPa for 304L 70% cold reduction to 1585 MPa for sample alloy 304L-0.6N 75% cold reduction, which was 19.6% increase. The ultimate strength increased from 550 MPa for 304L hot rolled to 882 MPa for sample alloy 304L-0.6N annealed, which was 60.4% increase. The yield strength increased from 1000 MPa for 304L 70% cold reduction to 1394 MPa for sample alloy 304L-0.6N 75% cold reduction, which was 19.6% increase. The yield strength increased from 255 MPa for 304L hot rolled to 460 MPa for sample alloy 304L-0.6N annealed, which was 60.4% increase. The elongation or ductility increased from 3% for 304L 70% cold reduction to 6% for sample alloy 304L-0.6N 75% cold reduction, which was 100% increase.

The elongation or ductility increased from 61% for the 304L hot rolled alloy to 65% for sample alloy 304L-0.6N annealed, which was 6.6% increase. The increased ductility may improve fatigue resistance of the alloy.

The magnetic permeability for the nitrided alloys was also reduced. For example, the magnetic permeability decreased from 2.50μ for 304L 70% cold reduction to 1.15μ for sample alloy 304L-0.6N 75% cold reduction. The magnetic permeability decreased from 1.15μ for 304L hot rolled to 1.00μ for sample alloy 304L-0.6N annealed.

The corrosion resistance was significantly improved from poor to be good with a corrosion resistance of at least 1250 mVsce for the nitride alloy 304LN 75% cold roll and 304LN annealed alloy, compared to the 304L 70% cold roll alloy and the 304L 70% cold roll alloy without nitriding.

TABLE 2
Comparisons of Properties of 304LN with 304L Stainless Steels

| | | Increase | | | | | | |
|---|---|---|---|---|---|---|---|---|
| | Ultimate | in | | Increase | | | | |
| | Tensile | Ultimate | Yield | in Yield | | | | |
| | Strength | Strength | Strength | Strength | Elong. | Elong. | Magnetic | Corrosion |
| | (MPa) | (%) | (MPa) | (%) | (%) | (%) | permeability | Resistance |
| 304L Hot | 550 | 0 | 255 | 0 | 61 | 0 | 1.15μ | poor |
| rolled | | | | | | | | |
| 304LN | 882 | 60.4 | 460 | 80.4 | 65 | 6.6 | 1.00μ | ≥1250 |
| annealed | | | | | | | | mVsce |
| 304L | 1325 | 0 | 1000 | 0 | 3 | 0 | 2.50μ | poor |
| 70% cold | | | | | | | | |
| roll | | | | | | | | |
| 304LN | 1585 | 19.6 | 1394 | 39.4 | 6 | 100 | 1.15μ | ≥1250 |
| 75% cold | | | | | | | | mVsce |
| roll | | | | | | | | |

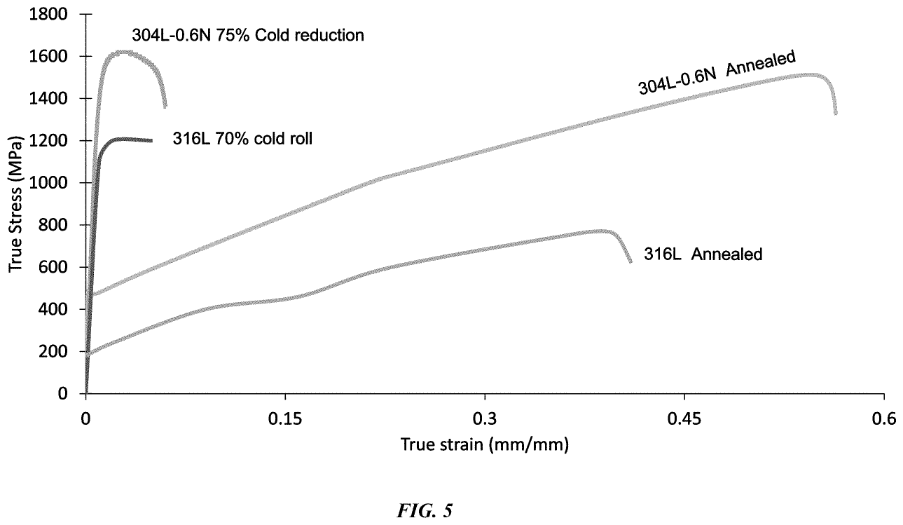

FIG. 5 illustrates true stress versus true strain curve for the 316L and 304LN alloys in accordance with embodiments of the disclosure. As shown in FIG. 5, the ultimate strength for sample alloy 304L-0.6N 75% cold reduction was higher than the sample alloy 316L 70% cold reduction. Also, the 304L-0.6N annealed sample alloy had higher ductility than the sample alloy 316L annealed. The results of FIG. 5 are summarized in Table 3.

Table 3 lists comparisons of properties of 304LN with 316L stainless steels. As shown, the ultimate strength increased from 1200 MPa for 316L 70% cold roll to 1585 MPa for sample alloy 304L-0.6N 75% cold roll, which was 32.1% increase. The yield strength increased from 1100 MPa for 316L 70% cold roll to 1394 MPa for sample alloy 304L-0.6N 75% cold roll, which was 26.7% increase. The elongation or ductility increased from 5% for 316L 70% cold roll to 6% for sample alloy 304L-0.6N 75% cold roll.

The magnetic permeability for the 316L 70% cold roll alloy was in the same range as for the sample alloy 304L-0.6N 75% cold roll alloy. The corrosion resistance for 316L 70% cold roll alloy was good with a corrosion resistance of at least 1150 mVsce, similar to the sample alloy 304L-0.6N 75% cold roll or cold reduction or cold work reduction.

TABLE 3
Comparisons of Properties of 304LN with 316L Stainless Steels

| | | Increase | | | | | |
|---|---|---|---|---|---|---|---|
| | Ultimate | in | | Increase | | | |
| | Tensile | Ultimate | Yield | in Yield | | | Corrosion |
| | Strength | Strength | Strength | Strength | Elongation | Magnetic | Resistance |
| | (MPa) | (%) | (MPa) | (%) | (%) | permeability | (mVsce) |
| 316L | 1200 | 0 | 1100 | 0 | 5 | 1.01μ-1.50μ | 1150 |
| 70% | | | | | | | |
| cold roll | | | | | | | |
| 304LN | 1585 | 32.1 | 1394 | 26.7 | 6 | 1.15μ | 1250 |
| 75% | | | | | | | |
| cold roll | | | | | | | |

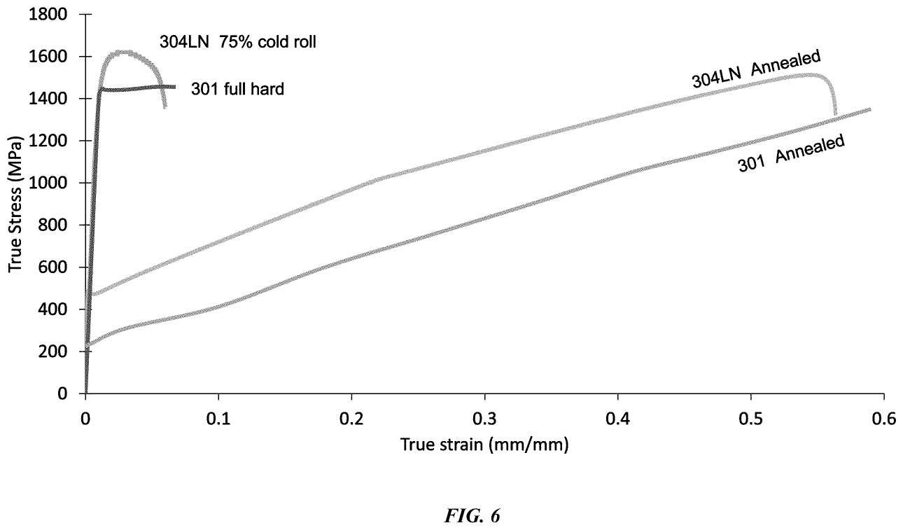

FIG. 6 illustrates true stress versus true strain curve for the 301 and 304LN alloys in accordance with embodiments of the disclosure. As shown in FIG. 6, the ultimate strength for sample alloy 304L-0.6N 75% cold roll was higher than the sample alloy 301 full hard. Also, the 304L-0.6N annealed sample alloy had higher ductility than the sample alloy 301 annealed. The results of FIG. 6 are summarized in Table 4.

Table 4 lists comparisons of properties of 304LN with 301 stainless steels. As shown, the ultimate strength increased from 1455 MPa for 301 full hard to 1585 MPa for sample alloy 304L-0.6N 75% cold roll, which was 8.9% increase. The yield strength slightly decreased from 1415 MPa for 301 full hard to 1394 MPa for sample alloy 304L-0.6N 75% cold roll, which was 1.5% decrease. The elongation or ductility slightly decreased from 6.7% for 301 full hard to 6% for sample alloy 304L-0.6N 75% cold roll.

The magnetic permeability for 301 full hard was greater than 50μ, and was thus magnetic, while the sample alloy 304L-0.6N 75% cold roll had low permeability of 1.15μ and was thus non-magnetic.

The corrosion resistance for 301 full hard was poor, while the corrosion resistance for sample alloy 304L-0.6N 75% cold roll was good with a corrosion resistance of at least 1250 mVsce.

TABLE 4
Comparisons of Properties of 304LN SS with 301 SS

| | | Increase | | | | | |
|---|---|---|---|---|---|---|---|
| | Ultimate | in | | Increase | | | |
| | Tensile | Ultimate | Yield | in Yield | | | |
| | Strength | Strength | Strength | Strength | Elongation | Magnetic | Corrosion |
| | (MPa) | (%) | (MPa) | (%) | (%) | permeability | Resistance |
| 301 full | 1455 | 0 | 1415 | 0 | 6.7 | >50μ | poor |
| hard | | | | | | | |
| 304LN | 1585 | 8.9 | 1394 | −1.5 | 6 | 1.15μ | good |
| 75% | | | | | | | |
| cold roll | | | | | | | |

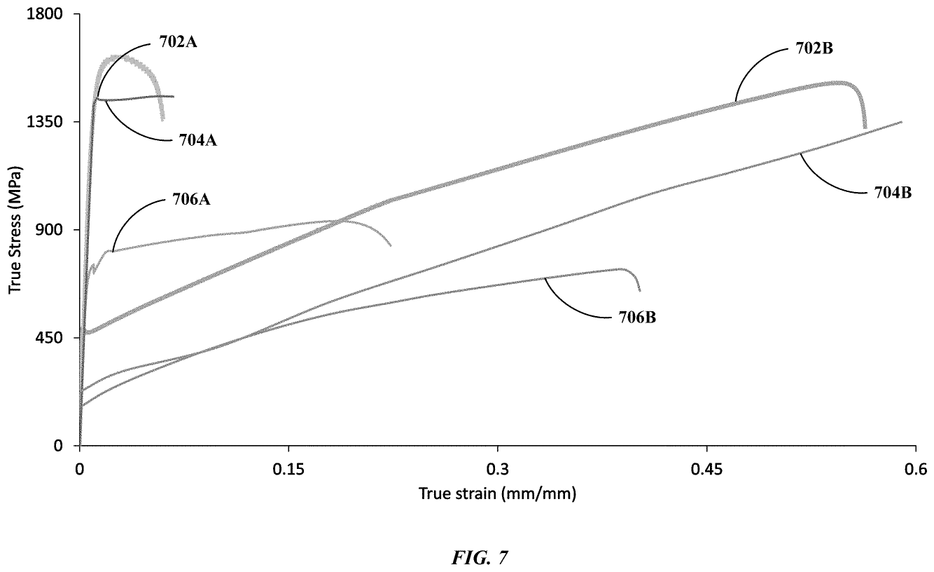

FIG. 7 illustrates true stress versus true strain curve for comparison of the 304LN alloy with other Fe-based alloys in accordance with embodiments of the disclosure. As shown, curve 702A represents 304LN full hard, curve 702B represents 304LN annealed, curve 704A represents 301 full hard, curve 704B represents 301 annealed, curve 706A represents 316L half hard, and curve 706B represents 316L annealed. 304LN had higher ultimate strength than both 301 and 316L alloys, in both cold work and annealed conditions.

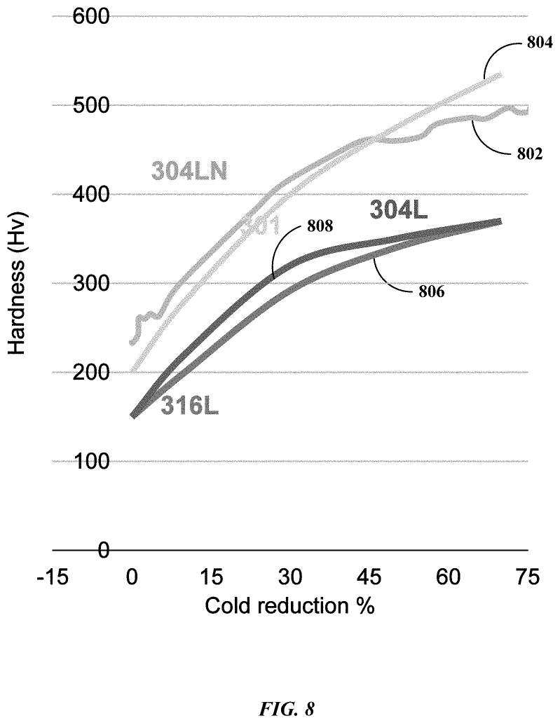

FIG. 8 illustrates hardness versus cold work reduction for the 304LN alloy and other Fe-based alloys in accordance with embodiments of the disclosure. Curves 802, 804, 806, and 808 represent 304LN, 301, 316L, and 304L 70% cold roll alloys, respectively. The hardness increased with the cold work reduction up to about 75%. As shown in FIG. 8, the hardness was about 500 Hv for the 304LN 70% cold work reduction alloy or 70% cold roll alloy, which was slightly lower than about 520 Hv for the 301 70% cold roll alloy. The hardness for the 316L alloy was lower than that of 301 and 304LN alloys. For comparison, the 304L alloy-70% cold roll had a hardness of 370 Hv, which is significantly lower than the nitrided 304LN 70% cold work reduction alloy.

### Example 2: 316N and 316LN Stainless Steels

Table 5 lists the alloy composition for 316N and 316LN stainless steels. 316N SS represents nitrided stainless steel with low carbon less than or equal to 0.08 wt %, while 316LN SS represents nitrided stainless steel with low carbon less than or equal to 0.03 wt %. The disclosed 316N and 316LN stainless steels have different values for Cr and Ni from conventional 316 stainless steels. For example, the conventional 316 stainless steels include 16 to 18 wt % Cr, and 10 to 14 wt % Ni.

TABLE 5
316N SS and 316LN SS

| | 316N | 316LN |
|---|---|---|
| C (maximum wt %) | 0.08 | 0.03 |

| | |
|---|---|
| Cr (range wt %) | 13.00-15.00 |
| Ni (range wt %) | 8.00-11.50 |
| Mo (range wt %) | 2-3 |
| Mn (maximum wt %) | 2.00 |
| Si (maximum wt %) | 0.75 |
| N (maximum wt %) | 0.90 |

Again, the solubility of N in the 316 stainless steel varies with nitriding conditions, such as temperature and gas pressure. The estimated maximum solubility of nitrogen for the 316 stainless steel was determined to be 0.90 wt % by simulations for various alloy compositions under various processing conditions including temperatures and gas pressures.

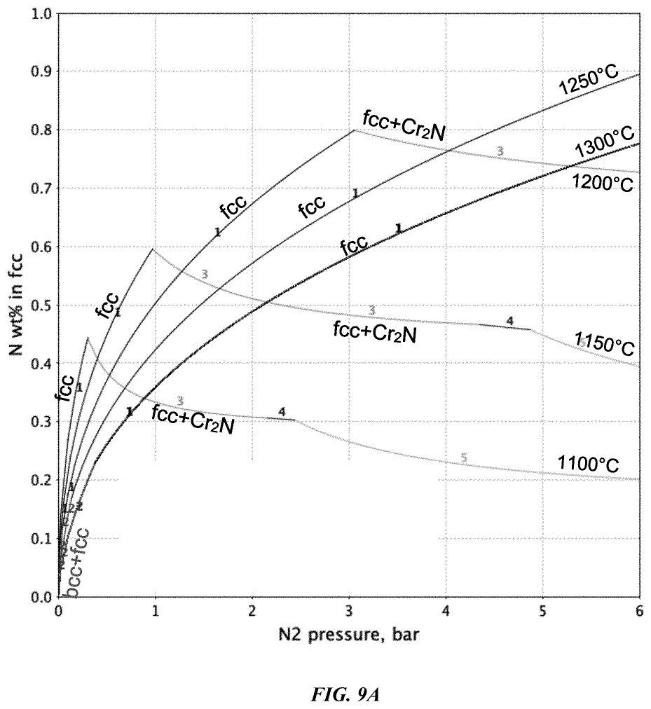

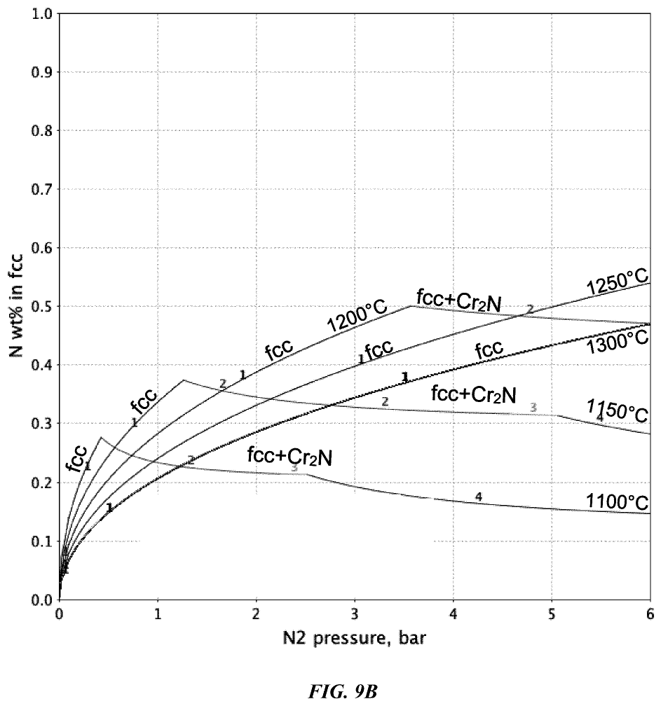

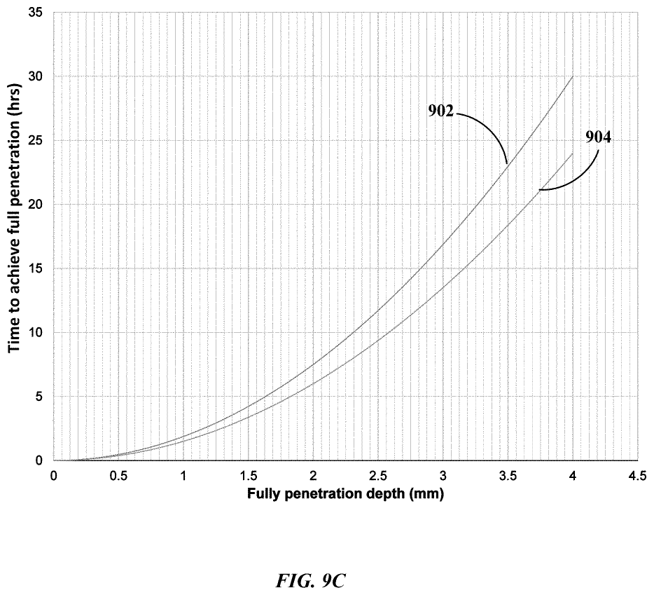

FIG. 9A illustrates nitrogen solubility versus N₂ gas pressure at various elevated temperatures for an example 316L alloy (Fe-18Cr-10Ni-3Mo-1.9Mn-0.4Si-0.02C-0.1N) in accordance with embodiments of the disclosure. As shown in FIG. 9A, the N wt % in FCC depended upon N₂ gas pressure. The BCC phase was present at high temperatures from 1100° C. to 1300° C. When the N₂ gas pressure was lower than 0.3 bars and the N wt % in FCC was less than 0.23, a mixture of BCC and FCC was present for the Fe-18Cr-10Ni-3Mo-1.9Mn-0.4Si-0.02C-0.1N alloy. When the N₂ gas pressure was higher than 0.3 bars and the N wt % in FCC was equal to or larger than 0.23, there was only FCC present.

The estimated maximum solubility for N in FCC was found for the Fe-18Cr-10Ni-3Mo-1.9Mn-0.4Si-0.02C-0.1N alloy. Further, the N wt % in FCC varied with N₂ gas pressures and temperatures. At temperatures 1250° C. and 1300° C., the N solubility in FCC increased with the N₂ gas pressure. However, at temperatures 1100° C., 1150° C., and 1200° C., the N solubility in FCC increased with the N₂ gas pressure at N₂ gas pressure up to about 0.5 bars, 1 bar, 3 bars, respectively, and then decreased with the N₂ gas pressure up to 6 bars. The estimated maximum solubility for N in FCC was 0.9 wt % achieved at 6 bars and 1250° C. in the temperature range from 1100° C. to 1300° C. and the N₂ gas pressure from 0 to 6 bars for the Fe-18Cr-10Ni-3Mo-1.9Mn-0.4Si-0.02C-0.1N alloy.

FIG. 9B illustrates nitrogen solubility versus N₂ gas pressure at various elevated temperatures for an example 316L alloy (Fe-16Cr-14Ni-2Mo-1.0Mn-0.75Si-0.02C-0.1N) in accordance with embodiments of the disclosure. As shown in FIG. 9B, the estimated minimum solubility for N in the 304L alloy was found for the Fe-16Cr-14Ni-2Mo-1.0Mn-0.75Si-0.02C-0.1N alloy. The BCC phase was absent at high temperatures from 1100° C. to 1300° C. Also, the N wt % in FCC varied with N₂ gas pressures and temperatures. At temperatures 1250° C. and 1300° C., the N solubility in FCC increased with the N₂ gas pressure. However, at temperatures 1100° C., 1150° C., and 1200° C., the N solubility in FCC increased with the N₂ gas pressure at N₂ gas pressure up to about 0.5 bars, 1.3 bars, 3.6 bars, respectively, and then decreased with the N₂ gas pressure up to 6 bars. The for N in FCC was up to 0.54 wt % achieved at 6 bars and 1250° C. in the temperature range from 1100° C. to 1300° C. and the N₂ gas pressure from 0 to 6 bars for the Fe-16Cr-14Ni-2Mo-1.0Mn-0.75Si-0.02C-0.1N alloy.

FIG. 9C illustrates penetration depth versus nitriding time for a 316L alloy in accordance with embodiments of the disclosure. As shown in FIG. 9C, curve 902 represents nitriding at 1850° C. and a N₂ gas pressure of 1.25 bar, and curve 904 represents nitriding at 1850° C. and a N₂ gas pressure of 1.85 bar. The penetration depth increases with the nitriding time as shown for both curves 902 and 904. Also, a lower N₂ gas pressure of 1.25 bar yielded faster N₂ penetration than a higher N₂ gas pressure of 1.85 bar.

It will be appreciated by one of the skilled in the art that the estimated maximum solubility of N in the alloy may vary with the ranges of the temperature and N₂ gas pressure and the alloy composition.

### Example 3: 301N and 301LN Stainless Steels

Table 6 lists the alloy composition for 301N SS and 301LN SS. 301N SS represents nitride stainless steels with low carbon less than or equal to 0.15 wt %. 301LN SS represents nitrided stainless steels with low carbon less than or equal to 0.03 wt %. The disclosed 301N SS and 301LN SS have the same values for Cr and Ni from the conventional 301 stainless steels. For example, the conventional 301 stainless steels include 16 to 18 wt % Cr and 6 to 8 wt % Ni.

TABLE 6
301N SS and 301 LN SS

| | 301N SS | 301 LN SS |
|---|---|---|
| C (maximum wt %) | 0.15 | 0.03 |

| | |
|---|---|
| Cr (range wt %) | 16.00-18.00 |
| Ni (range wt %) | 6.00-8.00 |
| Mn (maximum wt %) | 2.00 |
| Si (maximum wt %) | 0.75 |
| N (maximum wt %) | 0.96 |

Again, the solubility of nitrogen in the 301 stainless steel varies with nitriding conditions, such as temperature and gas pressure. The estimated maximum solubility of nitrogen for the 301 stainless steel was determined to be 0.96 wt % by simulations for various alloy compositions under various processing conditions including temperatures and gas pressures.

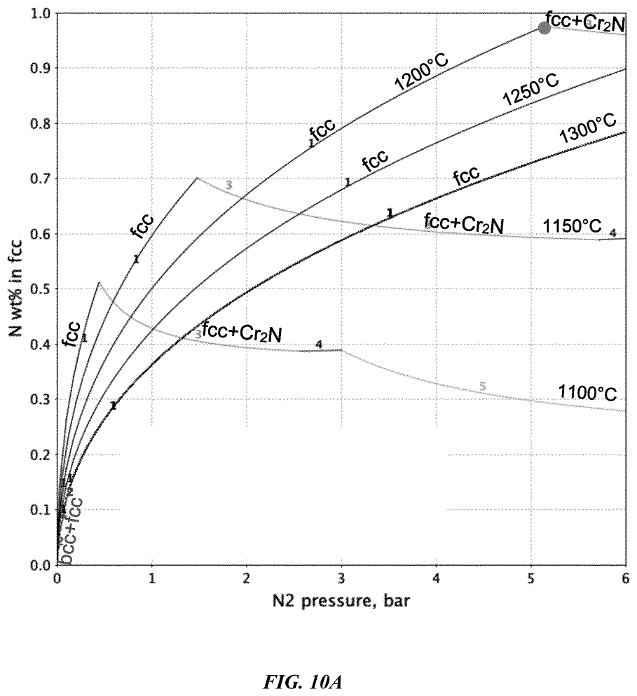

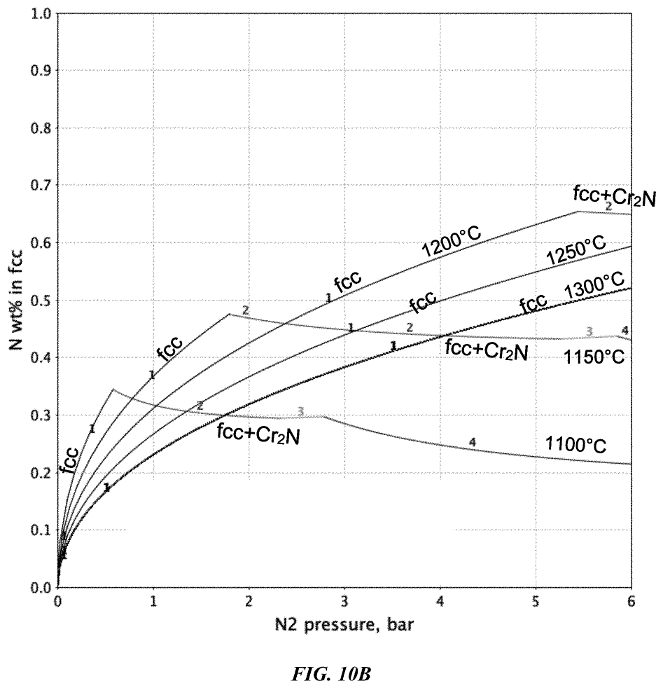

FIG. 10A illustrates nitrogen solubility versus N₂ pressure at various elevated temperatures for an example 301L alloy (Fe-18Cr-6Ni-1.9Mn-0.4Si-0.12C-0.1N) in accordance with embodiments of the disclosure. As shown in FIG. 10A, the N wt % in FCC depended upon N₂ gas pressure. The BCC phase was present at high temperatures from 1100° C. to 1300° C. When the N₂ gas pressure was lower than 0.3 bars and the N wt % in FCC was less than 0.23, a mixture of BCC and FCC was present for the Fe-18Cr-6Ni-1.9Mn-0.4Si-0.12C-0.1N alloy. When the N₂ gas pressure was higher than 0.3 bars and the N wt % in FCC was equal to or larger than 0.23, there was only FCC present.

The estimated maximum solubility for N in FCC was found for the Fe-18Cr-6Ni-1.9Mn-0.4Si-0.12C-0.1N alloy. Further, the N wt % in FCC varied with N₂ gas pressures and temperatures. At temperatures 1200° C., 1250° C., and 1300° C., the N solubility in FCC increased with the N₂ gas pressure. However, at temperatures 1100° C. and 1150° C., the N solubility in FCC increased with the N₂ gas pressure at N₂ gas pressure up to about 0.5 bars or 1.5 bar, respectively, and then decreased with the N₂ gas pressure up to 6 bars. The estimated maximum solubility for N in FCC was 0.96 wt % achieved at about 5.2 bars and 1200° C. in the temperature range from 1100° C. to 1300° C. and the N₂ gas pressure from 0 to 6 bars for the Fe-18Cr-6Ni-1.9Mn-0.4Si-0.12C-0.1N alloy.

FIG. 10B illustrates nitrogen solubility versus N₂ pressure at various elevated temperatures for an example 301L alloy (Fe-16Cr-8Ni-1.0Mn-0.8Si-0.12C-0.1N) in accordance with embodiments of the disclosure. As shown in FIG. 10B, the estimated minimum solubility for N in the 304L alloy was found for the Fe-16Cr-8Ni-1.0Mn-0.8Si-0.12C-0.1N alloy. The BCC phase was absent at high temperatures from 1100° C. to 1300° C. Also, the N wt % in FCC varied with N₂ gas pressures and temperatures. At temperatures 1200° C., 1250° C. and 1300° C., the N solubility in FCC increased with the N₂ gas pressure. However, at temperatures 1100° C. and 1150° C., the N solubility in FCC increased with the N₂ gas pressure at N₂ gas pressure up to about 0.5 bars or 1.8 bar, respectively, and then decreased with the N₂ gas pressure up to 6 bars. The for N in FCC was up to 0.65 wt % achieved at about 5.5 bars and 1200° C. in the temperature range from 1100° C. to 1300° C. and the N₂ gas pressure from 0 to 6 bars for the Fe-16Cr-8Ni-1.0Mn-0.8Si-0.12C-0.1N alloy.

It will be appreciated by one of the skilled in the art that the estimated maximum solubility of N in the alloy may vary with the ranges of the temperature and N₂ gas pressure and the alloy composition.

### Example 4: 3xx Stainless Steels

Table 7 provides example alloy compositions for certain 3xx stainless steels. The disclosed 3xx stainless steels, Alloys 1-5, have 16.00 to 21.00 wt % Cr and 8.00 to 13.00 wt % Ni, which are similar to that of the 304 stainless steels. However, Alloys 1-5 had higher Mn up to 0.5 wt % than the 304 stainless steel. The Mn contents in these 3xx stainless steels (Alloys 1-5) ranged from 4.00 to 5.00 wt %, which was higher than the 304, 316 and 301 stainless steels. Without wishing to be limited to any particular example or theory, the increased amount of Mn can help with improving nitrogen uptake and increased nitrogen content after nitriding. However, higher Mn can also negatively affect corrosion performance. As such, a maximum of 4.5 wt % was selected to achieve a balanced nitriding and corrosion resistance.

Also, as shown in Table 7, Alloys 2-5 had 0.05 wt % N prior to nitroding, while Alloy 1 did not have nitrogen prior to nitriding process.

TABLE 7
Compositions in wt % for 3xx Stainless Steels

| | | Alloy | Alloy | Alloy | Alloy | Alloy |
|---|---|---|---|---|---|---|
| Elements | Ranges | 1 | 2 | 3 | 4 | 5 |
| Cr | 16.00-21.00 | 18.00 | 16.00 | 19.00 | 19.00 | 20.00 |
| Ni | 8.00-13.00 | 11.00 | 8.00 | 10.00 | 10.00 | 11.50 |
| Mn | ≤4.50 | 5.00 | 4.00 | 4.00 | 4.00 | 4.00 |
| Mo | 0.00-4.00 | 2.60 | 2.00 | 1.00 | 0.00 | 0.00 |
| Si | 0.03-0.10 | 0.60 | 0.30 | 0.30 | 0.30 | 0.30 |
| N (prior to | ≤0.05 | 0.00 | 0.05 | 0.05 | 0.05 | 0.05 |
| nitriding) | | | | | | |
| N (after | ≤0.85 | 0.62 | 0.79 | 0.73 | 0.71 | 0.67 |
| nitriding) | | | | | | |
| C | 0.02-0.15 | 0.00 | 0.02 | 0.02 | 0.02 | 0.02 |
| S | 0.00-0.03 | 0.00 | 0.025 | 0.00 | 0.00 | 0.00 |

Higher Mn can increase the amount of N in the alloy. However, Mn can also reduce corrosion resistance. For the alloys having Mn around 4 wt % and 5 wt %. there seems to be a balance between maximum N and corrosion resistance.

Table 8 lists the N₂ gas pressure for nitriding, pitting resistance equivalent number (PREN) temperatures and the temperatures at which δ-phase starts for Alloys 1-5.

TABLE 8
Alloys 1-5

| | Alloy 1 | Alloy 2 | Alloy 3 | Alloy 4 | Alloy 5 |
|---|---|---|---|---|---|
| δ -phase start (° C.) | 1095 | 1240 | 1194 | 1266 | 1270 |
| Pressure (bar) | 1.227 | 3.220 | 1.32 | 1.36 | 0.96 |
| Base PREN | 26.58 | 23.4 | 23.1 | 19.8 | 20.8 |
| PREN 1170° C. | 36.5 | 35.24 | 33.98 | 30.36 | 30.72 |

As shown in Table 8, the N₂ gas pressures were 1.227 bar for Alloy 1, 1.32 bar for Alloy 3, 1.36 bar for Alloy 4, and 0.96 for Alloy 5, which were all below 2 bars. For Alloy 2, the N₂ gas pressure was 3.220 bar.

The δ-phase or δ-ferrite. is a body centered cubic (BCC) phase that exists at high temperature for austenite. The austenite at lower temperatures would change phase into austenite plus δ-ferrite at higher temperatures, as shown below:

Austenite(Low temperature)→Austenite+δ-ferrite(high temperature)

The δ-ferrite start temperature is the temperature at which δ-ferrite starts to precipitate from austenite. δ-phase is magnetic, which can limit the use of the alloy in certain application. The δ-phase has a sluggish nitriding response. If nitriding temperature is above the δ-start temperature, the alloy would be nitride in both austenite and δ phase, and the δ phase may not get nitride in the same way as the austenite. In some variations, this may create a galvanic couple which would harm the corrosion resistance of the alloy.

An empirical formula that estimates the corrosion resistance of a stainless steel based on its composition is as follows:

PREN=% Cr+(3.3×% Mo)+(16×% N)

As shown in the above formula, nitrogen has the highest coefficient for improving corrosion resistance. The base PREN in Table 8 is the value calculated before the material is nitrided, and the PREN 1170° C. in Table is the corrosion resistance after the material is nitrided at 1170° C. (PREN 1170° C.).

In some variations, Alloy 1 was not desired because Alloy 1 had its δ-start temperature much lower than 1170° C., so that Alloy 1 would have δ phase at the nitriding temperature.

### Example 5: Nitriding the Alloy During Solid State Powder Sintering

In some variations, the alloy can be in the form of powder. The metal powder can be formed of Fe-based alloy. Nitriding the powder can occur simultaneously with sintering the powder, which is referred to a dual sintering/nitriding process. The powder includes a plurality of particles.

In some variations, the metal powder may contain no nitrogen prior to the dual sintering/nitriding process. In some variations, the metal powder may contain nitrogen prior to the dual sintering/nitriding process. In some variations, the nitrogen content in the metal power may be up to 0.10 wt %.

Sintering is a process to make a solid or porous bulk material from powder by heating the powder to an elevated temperature without liquidation. During sintering, a compressive force or pressure can be applied. Massive movements that occur during sintering can reduce the total porosity by repacking. The mechanical properties, such as Young's modulus Eₙ, of sintered iron powder may vary with the density of the final product.

Nitriding is a heat treating process that diffuses nitrogen into a metal to increase the work hardening ability. In some variations, nitriding can be gas nitriding. The donor is a nitrogen gas (N₂) or a nitrogen rich gas (e.g. ammonia (NH₃)). When the nitrogen gas comes into contact with the heated powder during sintering, the nitrogen diffuses onto the powder, increasing the work hardening ability of the powder. The amount of nitrogen in the powder and the process parameters can be selected for particular properties required. The gas nitriding can have precise control of gas flow rate of nitrogen. The equipment cost is significantly lower than that of plasma nitriding.

Nitriding a powder is significantly faster than nitriding a bulk material, such as a cold rolled sheet, among others. This is because nitriding is a diffusion controlled process. The powder particles are significantly smaller than the bulk material. For example, the bulk material (e.g. rolled sheet) is at least 0.5 mm or thicker, while the powder particles have an average diameter equal to or less than 50 μm.

In some variations, the powder particles may have an average diameter equal to or less than 50 μm. In some variations, the powder particles may have an average diameter equal to or less than 45 μm. In some variations, the powder particles may have an average diameter equal to or less than 40 μm. In some variations, the powder particles may have an average diameter equal to or less than 35 μm. In some variations, the powder particles may have an average diameter equal to or less than 30 μm. In some variations, the powder particles may have an average diameter equal to or less than 25 μm. In some variations, the powder particles may have an average diameter equal to or less than 20 μm. In some variations, the powder particles may have an average diameter equal to or less than 15 μm. In some variations, the powder particles may have an average diameter equal to or less than 10 μm.

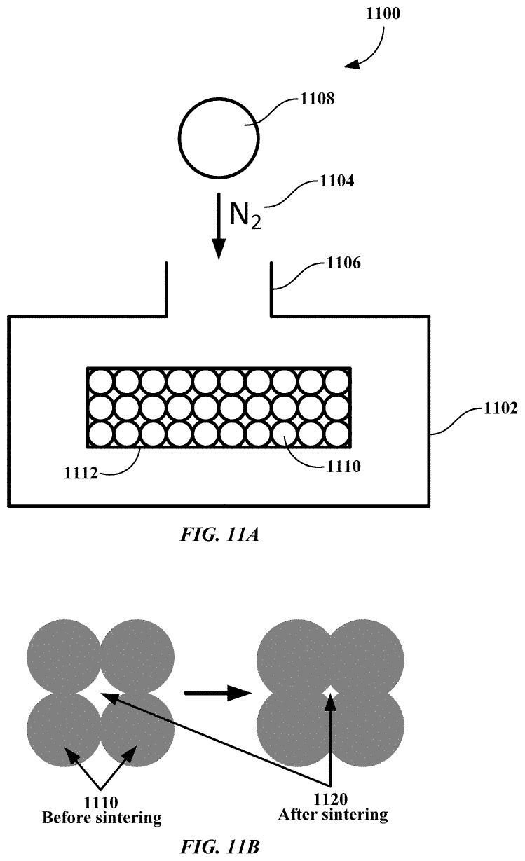

FIG. 11A depicts a sketch illustrating a system for dual sintering and nitriding of powder in accordance with embodiments of the disclosure. A system 1100 may include a sintering furnace 1102 having an inlet 1106 for filling a N₂ gas 1104 from a N₂ gas source 1108. A shaped article 1112 containing pre-compacted metal powder 1110 can be placed inside the system 1100. The shaped 1112 is pre-compacted from the metal powder and can be in any desired shaped. Nitriding the pre-compacted metal powder 1110 may be performed in the sintering furnace 1102 filled with the nitrogen gas 1104, as shown in FIG. 11.

FIG. 11B illustrates changes of packing particles after sintering in accordance with embodiments of the disclosure. As shown, there is a large pore 1120 between the powder particles 1110 prior to sintering, as shown on the left side. After sintering, the pore 1120 between the powder particles becomes smaller as shown on the right side and the contact area of powder particles with their neighboring particles also increases.

In some embodiments, nitriding may be performed at an elevated temperature for a period of time with a nitrogen gas. The elevated temperature for sintering is below the melting point of the major constituent of the metal powder such as iron. The furnace may be heated to at least 1000° C., alternatively to at least 1100° C., alternatively to at least 1200° C., or alternatively to 1300° C.

In some embodiments, the sintering furnace can be heated to the elevated temperature for a period of time. The period of time may depend on the average diameter of the powder particles. By way of example and not limitation, the larger the particles, the longer the nitriding time. In some variations, the time may be up to 30 hours.

In some variations, a nitrogen gas pressure may be up to 6 bars. In some variations, a nitrogen gas pressure may be up to 5 bars. In some variations, a nitrogen gas pressure may be up to 4 bars. In some variations, a nitrogen gas pressure may be up to 3 bars. In some variations, a nitrogen gas pressure may be up to 2 bars. In some variations, a nitrogen gas pressure may be up to 1 bar.

It will be appreciated by those skilled in the art that the gas pressure and furnace temperature, as well as nitriding time, may vary to affect the nitrogen content.

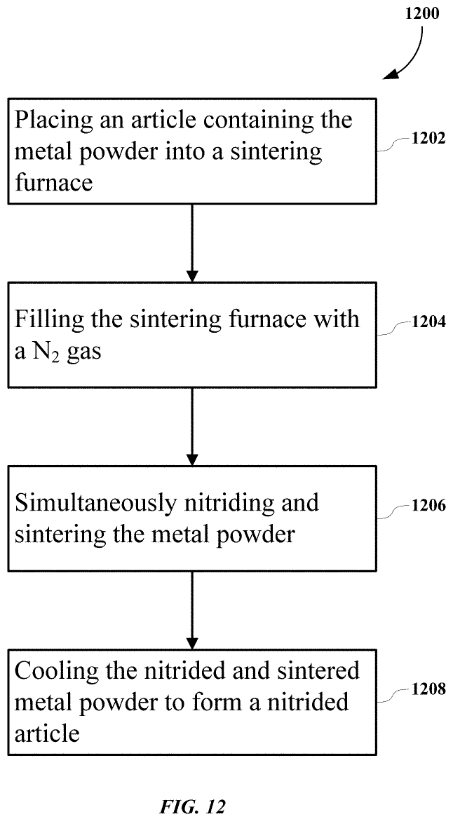

For the dual sintering/nitriding process, a nitrided steel article can be formed of any shape by sintering and nitriding simultaneously, for example, by using the system 1100. FIG. 12 is a flow chart illustrating the steps of dual sintering and nitriding of powder in accordance with embodiments of the disclosure. A method 1200 may include placing the shaped article 1112 containing the pre-compacted metal powder 1110 into the sintering furnace 1102 at operation 1202. The method may also include filling the sintering furnace 1102 with a N₂ gas at operation 1204. The method 1200 may also include simultaneously nitriding and sintering the metal powder by heating the pre-compacted metal powder 1110 at operation 1206. The method 1200 may further include cooling the nitrided and sintered metal powder to form a nitrided article at operation 1208.

In some variations, the steel can be heated in a furnace with a nitrogen gas, where the sintering temperature and the nitriding temperature are the same. In some variations, the nitriding time may vary from the sintering time by controlling the flow of the nitrogen gas. The nitriding time may be either longer or shorter than the sintering.

In some variations, a higher nitrogen content in the steel can be obtained through a longer duration sintering process. In some variations, the duration for sintering may be up to a few hours.

### Example 6: Dual Metal Injection Molding and Nitriding Powder

In some variations, the dual sintering/nitriding process can apply to metal 3D printing or metal injection molding (MIM) process. In the metal injection molding process, metal powder is mixed with a polymer binder to form a shaped article by using injection molding. The metal powder can be formed of Fe-based alloy. The metal injection molding process allows high volume, complex parts to be shaped in a single step.

In the dual metal injection molding and nitriding process, a nitrided steel article may be formed of any shape in an injection mold to the heat the powder with the polymer binder.

In some variations, the metal powder may not contain nitrogen prior to the dual metal injection molding and nitriding process.

In some variations, the metal powder may contain nitrogen prior to the dual metal injection molding and nitriding process.

In some variations, for the dual metal 3D printing and nitriding process, a nitrided steel article may also be formed of any shape by using laser or other means to the heat the powder in a nitrogen gas environment.

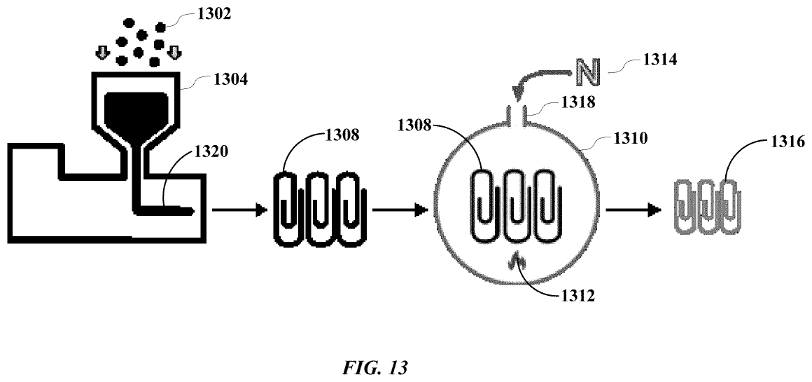

FIG. 13 depicts a sketch illustrating a system for dual metal injection molding and nitriding of powder in accordance with embodiments of the disclosure. A system 1300 for dual metal injection molding and nitriding may include a mold 1304 for molding the powder mixture or feedstock 1302 including a metal powder mixed with a polymer binder into a metal sheet 1320, which includes compacted metal powder mixed with the polymer binder. In this particular example, the metal sheet 1320 can be formed into a near or net shaped article 1308. It will be appreciated by those skilled in the art that the mold 1304 can be designed to form any shaped article 1308 which includes compacted metal powder mixed with the polymer binder.

The feedstock 1302 is an intermediate product including metal powder mixture with the polymer binder, and may have granule size of several millimeters. In some variations, the feedstock 1302 may be manufactured by the metal injection molding manufacturer. In some variations, the feedstock 1302 may also be provided by suppliers.

The near/or net shaped article 1308 is formed of the powder mixture including the metal powder mixed with the polymer binder or the feedstock 1302. The injection molding temperature may be lower than the melting temperature of the metal powder such that the metal powder remains unmelted to keep the metal powder in powder form. The polymer binder is an intermediate processing aid and will be removed from the product after burning off, nitriding, and consolidating in a single step.

The system 1300 may also include a chamber 1310 and a heating source 1312 for heating the chamber 1310. The heating source 1312 may be a laser or other means. The heating source 1312 may be placed inside the chamber 1310, such as shown in FIG. 13. The heating source 1312 may be placed outside the chamber 1310.

The system 1300 may also include a nitrogen gas source 1214 configured to connect to an inlet 1318 of the chamber 1310, such that the nitrogen gas can be supplied to the chamber at a controlled flow rate, time, and pressure. The system 1300 allows to heat the near or net shaped article 1308 placed inside the chamber 1310 by using the heat source 1312 and to nitride the near or net shaped article 1308. The nitrided article 1308 can be consolidated after thermally or chemically removing the polymer binder and cooled to room temperature to form a shrinked product 1316. The linear shrinkage of the near or net shaped article may range from 15% to 30% after consolidating. Consolidating is a sintering process to reduce pore volume.

In some variations, the shrinkage may be equal to or less than 30%. In some variations, the shrinkage may be equal to or less than 25%. In some variations, the shrinkage may be equal to or less than 20%. In some variations, the shrinkage may be equal to or greater than 15%. In some variations, the shrinkage may be equal to or greater than 20%. In some variations, the shrinkage may be equal to or greater than 25%.

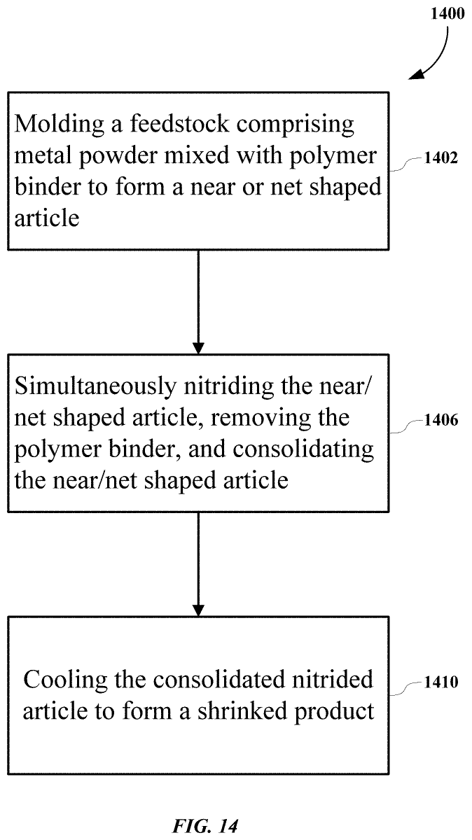

FIG. 14 is a flow chart illustrating the steps of dual metal injection molding and nitriding of powder in accordance with embodiments of the disclosure. A method 1400 may include molding the feedstock 1320 to form a near or net shaped article 1308 at operation 1402. The feedstock may be formed from the metal powder mixed with a polymer binder. The feedstock may be provided by a supplier or by a MIM manufacturer.

The method 1400 may also include simultaneously nitriding the near or net shaped article 1308, removing the polymer binder, and consolidating the near or net shaped article in a nitriding chamber 1310 with a nitrogen gas 1314 at operation 1406. During the nitriding of the near or net shape article at an elevated temperature, the polymer binder of the powder is removed either thermally or chemically, including burning off or evaporation, among others, and the powder is consolidated at the same time. When the polymer binder is removed, the near or net shaped article is an interconnected network with pores between the particles of metal powder. Nitrogen can diffuse into the particles of metal powder through the pores. Consolidating is a sintering process to reduce pore volume at the elevated temperature. Nitriding may be compatible with the MIM process or 3D printing process.

The method 1400 may also include cooling the consolidated nitrided near or net shaped article to form a shrinked product 1316 at operation 1410. The shrinked product can be a nitrided hardened article of any desired shape.

In some variations, the elevated temperature is the nitriding temperature. The nitriding temperature may be lower than the melting temperature of the metal powder such that the metal powder remains unmelted to keep the metal powder in powder form.

In some variations, the consolidating time is the same as the nitriding time.

In some variations, the consolidating time may be different from the nitriding time. For example, the consolidating time may be longer or shorter than the nitriding time. The nitrogen gas 1314 into the chamber 1310 can be controlled.

### Example 7: Nitriding an Alloy Comprising a Locally Molten Portion

In some variations, for metal 3D printing or metal injection molding (MIM) processes at high temperatures, such as laser powder bed and direct metal deposition process, locally melting a powder or a feedstock, e.g. a wire feedstock, can produce a part.

In some variations, the powder or feedstock may be non-nitrogen containing stainless steel alloys prior to nitriding. Alternatively, the powder or feedstock may be nitrogen containing stainless steel alloys prior to nitriding. The nitrogen containing stainless steel can include uniformly distributed nitrogen. In such instances, nitrogen-containing gas may be applied in the vicinity of a locally molten alloy to increase the nitrogen content of a final part.

Without wishing to be limited to any particular theory or mode of action, locally molten alloy can have fast diffusion of nitrogen than the alloy in a solid state at an elevated temperature because nitrogen can diffuse faster into a liquid than into the alloy in the solid state at the elevated temperature. Diffusing nitrogen into the locally molten alloy may be quite different than diffusing into the entire feedstock. The diffusion distance at which a species (e.g. N₂ gas) diffuses into a surface is proportional to the square root of diffusion time. Thus, when N₂ diffuses into the molten surface layer, for example, about 10 microns in thickness, the diffusion may be about 10,000 times faster than when diffusing into a solid piece of about 1 mm thick for the same material having a given diffusivity.

In some variations, the feedstock can include a pre-compacted Fe-based powder mixed with a polymer binder. The feedstock can include a locally molten portion, such as a surface portion or a bulk portion.

The feedstock may be in any shape or form. For example, the feedstock may be bar shaped with a thickness of a few millimeters. Alternatively, the feedstock can be partially molten or locally molten. For example, the feedstock may have a surface layer in a molten state or liquid state while the bulk material under the surface layer still remains in a solid state. In some variations, the molten surface layer may be on the order of micron in thickness. Nitrogen may diffuse into the molten surface layer, which may take a time on the order of 10 seconds.

In some variations, a finished part produced from nitriding the feedstock including locally molten alloy may have a non-uniform distribution of nitrogen. For example, the surface layer may include more nitrogen than the bulk. The surface layer may have a different property from the bulk.

### Example 8: Passivation

The passivation for the stainless steels can remove the free iron from the surface of the metal using an acid solution. A very thin inert layer (e.g. oxide layer or nitride layer) can be formed to protect the stainless steels from corrosion. In some variations, the acid solution may include acid, such as a citric acid (HNO₃) among others.

The operations following the passivation may include rinsing with water, neutralizing the passivated alloy with a salt solution, such as sodium carbonate (Na₂CO₃) among others, and rinsing the neutralized alloy.

In one example, a 304LN sample and a 316L were passivated with a citric acid solution with a concentration of about 4% (e.g. 4±0.5%) at about 65° C. (e.g. 65±2° C.) for about 10 minutes. The samples were rinsed with clean water or water with a high purity for a few times. Each rinse was about 90 seconds.

In one example, a 304LN sample and a 316L were passivated with the citric acid solution with a concentration of about 42% (e.g. 42+8% or 42-2%) at room temperature for about 60 minutes. The samples were rinsed with pure water for about 90 seconds for a few times.

The passivated samples were then neutralized by using the Na₂CO₃ solution with a concentration of 4±1% at room temperature for about 3 minutes, followed by rinsing with clean water or water with a high purity for a few times at room temperature for about 90 seconds each rinse, and then rinsed with warm water having a temperature ranging from 70° C. to 90° C. for about 3 minutes. After the rinsing, the samples were dried at 90° C. for about 30 minutes.

It was surprisingly found that passivation worked very well on nitrided 304L. Passivating 316L only reduced the corrosion rate by 60%. However, passivating nitrided 304L could reduce the corrosion rate by 99%, which was significantly higher than the result from the passivation (e.g. 316L). The higher nitrogen content in the nitrided 304L may make passivation more effective than the stainless steel without being nitride. The resultant oxide may be more tenacious than the stainless steel without being nitrided.

Any ranges cited herein are inclusive. The terms “substantially” and “about” used throughout this specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to 0.05%.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the invention. Accordingly, the above description should not be taken as limiting the scope of the invention. Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the method and system, which, as a matter of language, might be said to fall therebetween.

1. An Fe-based alloy comprising:
13-21 wt % Cr;
5-16 wt % Ni;
less than or equal to 6.0 wt % Mn;
0.035-2.0 wt % N;
less than or equal to 1.0 wt % Si; and
less than or equal to 0.15 wt % C,
wherein the balance is Fe and trace elements.

2. An Fe-based alloy of claim 1, comprising:
13-21 wt % Cr;
5-16 wt % Ni;
less than or equal to 3.0 wt % Mn;
0.035-2.0 wt % N;
less than or equal to 1.0 wt % Si; and
less than or equal to 0.15 wt % C,
wherein the balance is Fe and trace elements.

3. The Fe-based alloy of claim 2, comprising:
17-21 wt % Cr;
7-13 wt % Ni;
less than or equal to 3.0 wt % Mn;
0.035-1.50 wt % N;
less than or equal to 1.0 wt % Si; and
less than or equal to 0.10 wt % C.

4. The Fe-based alloy of claim 3, comprising:
18-20 wt % Cr;
8-12 wt % Ni; and
less than or equal to 2.00 wt % Mn.

5. The Fe-based alloy of claim 3, wherein the alloy comprises less than or equal to 0.03 wt % C.

6. The Fe-based alloy of claim 3, wherein the alloy has a ductility increase by at least 80% compared to the alloy having the same composition with N less than or equal to 0.03 wt %.

7. The Fe-based alloy of claim 3, wherein the alloy has an ultimate tensile strength increase by at least 15% compared to the alloy having the same composition with N less than or equal to 0.03 wt %.

8. The Fe-based alloy of claim 3, wherein the alloy has a tensile yield strength increase by at least 30% compared to the alloy having the same composition with N less than or equal to 0.03 wt %.

9. The Fe-based alloy of claim 3, wherein the alloy has a magnetic permeability less than 1.5μ.

10. The Fe-based alloy of claim 2 comprising:
15-19 wt % Cr;
10-16 wt % Ni;
1-4 wt % Mo;
less than or equal to 3.0 wt % Mn;
0.03-1.5 wt % N;
less than or equal to 1.0 wt % Si; and
less than or equal to 0.10 wt % C.

11. The Fe-based alloy of claim 10 comprising:
16-18 wt % Cr;
10-16 wt % Ni;
2-3 wt % Mo; and
less than or equal to 2.0 wt % Mn.

12. The Fe-based alloy of claim 10, wherein the alloy comprises less than or equal to 0.03 wt % C.

13. The Fe-based alloy of claim 10, wherein the alloy has a magnetic permeability less than 1.5μ.

14. The Fe-based alloy of claim 2, comprising:
15-19 wt % Cr;
5-9 wt % Ni;
less than or equal to 3.0 wt % Mn;
0.02-2.0 wt % N;
less than or equal to 1.0 wt % Si; and
less than or equal to 0.10 wt % C;
wherein the balance is Fe and trace elements.

15. The Fe-based alloy of claim 14 comprising:
16-18 wt % Cr;
6-8 wt % Ni; and
less than or equal to 2.0 wt % Mn.

16. The Fe-based alloy of claim 14, wherein the alloy comprises up to 0.03 wt % C.

17. The Fe-based alloy of claim 14, wherein the alloy has a magnetic permeability less than 1.5μ.

18. An Fe-based alloy of claim 1:
16 to 21 wt % Cr;
8 to 13 wt % Ni;
less than or equal to 6.0 wt % Mn;
0.035 to 2.0 wt % N;
0.03 to 1.0 wt % Si; and
0.02 to 0.15 wt % C,
wherein the balance is Fe and trace elements.

19. The alloy of claim 18, wherein the alloy further comprises equal to or less than 4.0 wt % Mo.

20. The alloy of claim 18, wherein the alloy further comprises at least 0.03 wt % S.

21. A method of hardening an Fe-based alloy, the method comprising:
cold rolling the Fe-based alloy to form a cold rolled alloy; and
heating the cold rolled alloy to an elevated temperature in a nitrogen-containing gas to form a nitrided hardened Fe-based alloy,
wherein the nitrided hardened Fe-based alloy comprises N from 0.035 to 2.0 wt %.

22. (canceled)

23. (canceled)

24. (canceled)

25. (canceled)

26. (canceled)

27. (canceled)

28. A method of forming a nitrided hardened sintered Fe-based article, the method comprising:
placing an article containing a pre-compacted Fe-based powder inside a sintering furnace;
filling the sintering furnace with a N₂ gas; and
simultaneously sintering and nitriding the article comprising the pre-compacted Fe-based powder to an elevated temperature to form a nitrided and sintered Fe-based article;
wherein the nitrided and sintered Fe-based article comprises N from 0.035 to 2.0 wt %.

29. (canceled)

30. (canceled)

31. (canceled)

32. (canceled)

33. A method of 3D printing or metal injection molding an Fe-based powder, the method comprising:
molding a feedstock comprising a pre-compacted Fe-based powder mixed with a polymer binder to form a shaped article;
simultaneously a) sintering and b) nitriding the shaped article and c) removing the polymer binder in a nitrogen-containing gas at an elevated temperature to form a nitrided hardened Fe-based article,
wherein the nitrided hardened Fe-based powder comprises N from 0.035 to 2.0 wt %.

34.-40. (canceled)
